(19) United States
(12) Patent Application Publication
(10) Pub. No.: US 2020/0053523 A1
(43) Pub. Date: Feb. 13, 2020

(54) SYSTEM AND METHOD FOR AUTOMATED RADIO FREQUENCY SAFETY SYSTEM FOR MULTIPLE/SINGLE DISTRIBUTED ANTENNA SYSTEMS

(71) Applicant: RF Check, Inc., San Diego, CA (US)

(72) Inventor: Douglas M. Williams, Del Mar, CA (US)

(21) Appl. No.: 16/656,118

(22) Filed: Oct. 17, 2019

Related U.S. Application Data
(63) Continuation of application No. 14/640,876, filed on Mar. 6, 2015, now abandoned.
Application No. 14/640,876 is a continuation-in-part of application No. 13/933,966, filed on Jul. 2, 2013, now abandoned.
Application No. 13/933,966 is a continuation-in-part of application No. 12/023,901, filed on Jan. 31, 2008, now Pat. No. 8,583,446.
Application No. 12/023,901 is a continuation-in-part of application No. 11/394,555, filed on Mar. 31, 2006, now Pat. No. 7,570,922.
Application No. 11/394,555 is a continuation-in-part of application No. 11/100,947, filed on Apr. 6, 2005, now abandoned.
Application No. 11/100,947 is a continuation-in-part of application No. 10/215,495, filed on Aug. 8, 2002, now abandoned.

(51) Int. Cl. H04W 4/33; G06Q 30/00; H04W 4/90; G06Q 10/10; G01S 5/00; G01S 5/02

(52) U.S. Cl. CPC H04W 4/33; G06Q 30/018; H04W 4/90; G06Q 50/265; G01S 5/00; G01S 5/02; G06Q 10/10

(57) ABSTRACT

Collecting and maintaining information about all sources of RF radiation within commercial and public structures in a computer database. In one aspect this is a living database consisting of millions of structures including their associated RF transmitting devices and unique characteristics. The database includes energy transmissions information including site specific physical locations, building layouts including all interior floorplans; and the exact positions of all sources of RF radiation located on floorplans, including their vertical positions and utilization characteristics. The System can deliver MPE maps of radio frequency radiation and site specific safety programs to anyone working in or visiting a commercial and public structure containing wireless transmitters in the United States. These maps and site specific safety programs are updated daily. The System can be accessed via the Internet by registered users. The System creates and displays MPE maps and radiation patterns showing gradation power densities to identify exposure dangers.

### RELATED APPLICATIONS

This application is a continuation of U.S. application Ser. No. 14/640,876, filed Mar. 6, 2015, which is a continuation-in-part of U.S. application Ser. No. 13/933,966, filed Jul. 2, 2013, which is a continuation-in-part of U.S. application Ser. No. 12/023,901, filed Jan. 31, 2008 (now U.S. Pat. No. 8,583,446, issued Nov. 12, 2013), which is a continuation-in-part of U.S. application Ser. No. 11/394,555, filed Mar. 31, 2006 (now U.S. Pat. No. 7,570,922, issued Aug. 4, 2009), which is a continuation-in-part of U.S. application Ser. No. 11/100,947, filed Apr. 6, 2005, which is a continuation-in-part of U.S. application Ser. No. 10/215,495, filed Aug. 8, 2002; all of which are hereby incorporated by reference.

### BACKGROUND

### Field of the Invention

This invention relates generally to radio frequency exposure safety and to a system for monitoring and controlling energy transmission within a building.

### Related Art

The current systems of protecting people from radio frequency (“RF”) exposure are inadequate and often in violation of existing state and federal regulations. Antennas may be located on top of a building, such as a commercial office. People within the building, such as office workers, are subject to RF radiation due to the wireless signals from antennas located at the wireless transmission site on top of the building, as well as in-door antenna systems within the building used to retransmit or amplify the signals from the antennas or as the access points to Wireless Local Area Networks (WLAN). These antennas may be cells such as macrocells, microcells, and picocells. Indoor antenna systems, such as indoor distributed antenna systems (“inDAS”), are one example of a RF radiating technology, which are used to transmit wireless signal within a building. Indoor distributed antenna systems, in combination with other RF radiating technologies, may exceed the safety precautions currently mandated by the Federal Communication Commission (“FCC”). Current RF safety regulations limit the power output of an individual component and do not take into account the contribution of multiple sources of RF radiation. The expanding demand for wireless services and network capacity will increase the number of sources of RF radiation. There is currently no coordination between the providers of these services and the monitoring of the cumulative effect of multiple sources of RF radiation.

There are currently enormous cellular networks consisting of thousands of base station antennas which are required to enable cell phone use. The wireless signals from base station antennas can also be retransmitted or amplified by multiple or single indoor distributed antenna systems. These wireless transmission sites come with an environmental hazard as they generate RF radiation. RF radiation (“RFR”) is tasteless, odorless and invisible, increasing the need for a comprehensive RF safety compliance program. The damaging health effects from excessive RF exposures are well documented but may not be apparent until long after the exposures occurred.

Over a period of time wireless technology has migrated from solely transmitting data and voice from antennas located on outdoor structures such as buildings, public right of ways, light standards, etc. Today, much of the wireless traffic is generated within commercial and public structures from micro cells, WIFI access points, WLAN, and other RF producing devices. Because of the many sources of RF radiation, a need exists to inform and protect individuals within these structures from RF radiation.

### SUMMARY

Aspects of the present invention can include a system for providing access to radio transmission safety information relating to a radio transmission site while a person is at or near the radio transmission site. To properly calculate the correct RF exposure at any given location within a structure, all RF radiation producing devices, either licensed by the FCC or unlicensed must have their fixed location known and regularly monitored for accuracy. These locations can be depicted on the actual floor plans of every commercial and public structure. This is to account for any cumulative effect of overlapping RF radiation patterns created from any number of transmitting devices that has the potential to injure humans who either work in or visit any given commercial or public structure. The floor plans made available by the system can be accessed and used by emergency personnel such as members of fire departments, police departments and Homeland Security. In an emergency situation such as a fire, terrorist attack or hostage situation, the floor plans can be quickly accessed by authorized emergency personnel and can provide vital information.

The system can include a database including data on a plurality of buildings and transmitters emitting radio frequency (RF) radiation to or inside one or more of the plurality of buildings. In addition, the system can include a maximum permissible exposure (MPE) mapping module configured to display a building's antennas and transmitters with associated elements, calculate a building's associated MPE limits, and create graphic representation of MPE maps.

In a further aspect, the system's database can include data on at least one floor plan of one or more of the plurality of buildings. The system can include an indoor positioning system having coordinates and the unique identification of each transmitter in relation to the at least one floor plan in the database.

In a further aspect, the system further comprises a data update module configured to update the database if there is any change in transmitter configuration or when changes are made to one of the floor plans. Such changes made to one of the floor plans can include repositioning of one of the plurality of transmitters

In a further aspect, the system's database can include data on transmitters such as an indoor distributed antenna system (“inDAS”), a signal booster, a WLAN access point, or any other source of RF radiation.

In a further aspect, the system further comprises a building information display module configured to provide the floor plan of one of the buildings. The building information display module may be configured to be accessed by a first responder during an emergency.

In a further aspect, the system further comprises a power down request module configured to allow a user to request that the power of a transmitter or multiple transmitters at a building can be reduced or turned off.

In a further aspect, the system further comprises a building specific safety program module configured to maintain safety programs for the building and to update a safety program for the building when data associated with the building or transmitter configuration is changed.

Other features and advantages of the present invention should be apparent after reviewing the following detailed description and accompanying drawings which illustrate, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level block diagram illustrating an example network and the system.

FIG. 2 is a database diagram or schema illustrating an example of a site's attributes.

FIG. 3 is an example of a site plot map of a building illustrating a graphic representation of multiple sources of RF radiation.

FIG. 4 is a database diagram or schema illustrating the RF Certification and RF Safety Summary Sheet attributes.

FIG. 5 is a functional block diagram illustrating the functions or modules of one embodiment of the system.

FIG. 6 is a block diagram illustrating a controlled access to sites based on user's role in the system

FIG. 7 is a flow diagram of one embodiment of the process implemented by the QR access function.

FIG. 8A is a flow diagram of the power down request functions.

FIG. 8B is a flow diagram of the functions performed once a power down request is sent to the wireless telecommunications company.

FIG. 9 is a flow diagram of one embodiment of the process implemented by the data update module.

FIG. 10 is a graphical representation of a physical site related to a generalized site data structure.

FIG. 11 is a graphical representation of a system which can be employed to define the spatial relationships between multiple antenna structures at a site which are stored in the database.

FIG. 12 is an example of site plot map—a graphic representation of the antenna structures and other site elements site plot view.

FIG. 13 is a graphical representation of a single antenna system on the site including MPE Maps from top view perspective.

FIG. 14 is a graphical representation of a single antenna system on the site including MPE Maps from side view perspective.

FIG. 15A is a graphical representation of a MPE map from the top view perspective for three antennas with overlapping controlled and restricted areas represented.

FIG. 15B is a graphical representation of a MPE map from the top view perspective for two antennas with non-overlapping controlled and restricted areas represented.

FIG. 15C is a graphical representation of a MPE map from the side view perspective of an antenna.

FIG. 16 is a block diagram representation of the RF safety summary sheet.

FIG. 17 represents the power density as a contribution of two antenna radiations.

FIG. 18 represents the power density of a single antenna in different points in space.

FIG. 19 represents the power density contribution of two antennas to a point in space.

FIG. 20 represents participation of multiple antennas in the contribution model applied to an antenna array.

FIG. 21 is a flow diagram of one embodiment of an automated safety audit program.

FIGS. 22 and 23 are flow diagrams of one embodiment of the automated compliance audit program.

FIG. 24 is a flow diagram of functionality provided by the RF certification module 429 of FIG. 5 which allows an employer to provide his employee with site-specific RF safety summary sheets.

FIG. 25 is a flow diagram of further functionality provided by the RF certification module 429 of FIG. 5 which allows a user to provide contractor companies the system functionalities of site access, training and certification similar to that provided for employees.

FIG. 26 is a flow diagram of further functionality provided by the RF certification module 429 of FIG. 5 which ensures a user's required RF certification before starting to use the system.

FIG. 27 is a flow diagram of further functionality provided by the RF certification module 429 of FIG. 5 which allows user to be RF certified upon his own request.

FIG. 28 is a flow diagram of further functionality provided by the RF certification module 429 of FIG. 5 and shows in details user's account activation including required RF certification.

### DETAILED DESCRIPTION

Certain embodiments as disclosed herein provide for systems and methods for a wireless location monitoring and reporting system (“System”).

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The present invention includes a method for using an information storage and retrieval system and includes establishing a database structure enabling the storage of information concerning the locations and utilization characteristics of wireless radio frequency (RF) transmitting antennas and the places with existing antennas (referred to as sites). These sites may include wireless transmitters, such as cellular antennas, in-door distributed antenna systems (inDAS), individual signal boosters, and WLAN networks such as Wi-Fi (collectively referred to as “transmitters”). Some of these transmitters may be located within structures such as a building, such as the inDAS, individual signal boosters, and WLAN networks. All transmitters can transmit wireless signals through the air. WLAN and inDAS systems may be composed of multiple antennas and may act as a single antenna system. The system and methods provide site-specific safety information and tools for protecting workers from RFR hazards and provide auditing in order to document compliance with applicable regulations.

Electronic access to the information database can be made available over the Internet to the Systems' subscribers, referred to as “users” in this specification. Additionally, Maximum Permissible Exposure (MPE) maps and the data necessary to create the spatial representations of the site configuration are created using the information database. The Systems and methods described herein can provide greater worker safety, eliminate the disproportional amount of liability currently shouldered by wireless telecommunication companies, and reduce RF exposure to persons involved in site management.

Additionally, workers, first responders and users of the system can be provided with a simplified access process to information for a site which is identified by machine readable indicia which is read by a user device, for example, a cellular telephone. The machine readable indicia can be, for example, a matrix barcode (such as a QR (quick response) code). The QR code is preferably located at the site on a sign warning of the RF radiation hazard.

FIG. (“FIG.”) 1 is a high level block diagram of an example network including the System 100. The System 100 can communicate with users via an external network 114 such as the internet. Reference to a user or users herein refer to individuals interacting with the System 100 (and other embodiments described herein) via a computer interface. The computer interface can be directly with the System or via another computer or device which communicates with the System. As an example, the remote user devices 110 a-c and a remote raw data provider device 112 are shown. Remote user devices include traditional computers, mobile computers, mobile telephones, smart phones and other mobile or fixed computing devices which can provide a user interface (e.g., a display an input mechanism) and access to the System via a network such as the internet. The System also includes a system and database administration module 128 within the company intranet 126 which can interact with the System directly. When communication traffic first enters the System 100 it passes through a data switch unit (“DSU”) 116. The traffic from the DSU is passed to a web router 118. From the web router the traffic flows to the web application servers 120. The web application servers in general, provide user interfaces. In one embodiment the web application servers include a primary load balanced application server and a back-up secondary server. The web application servers 120 communicate through a firewall router 122 with the database servers 124.

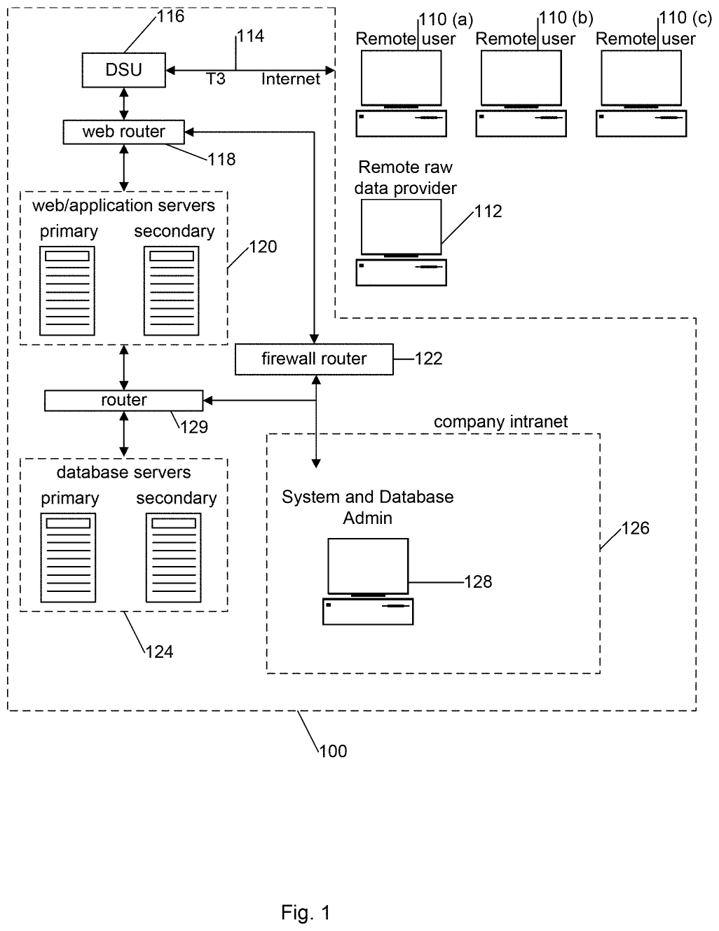

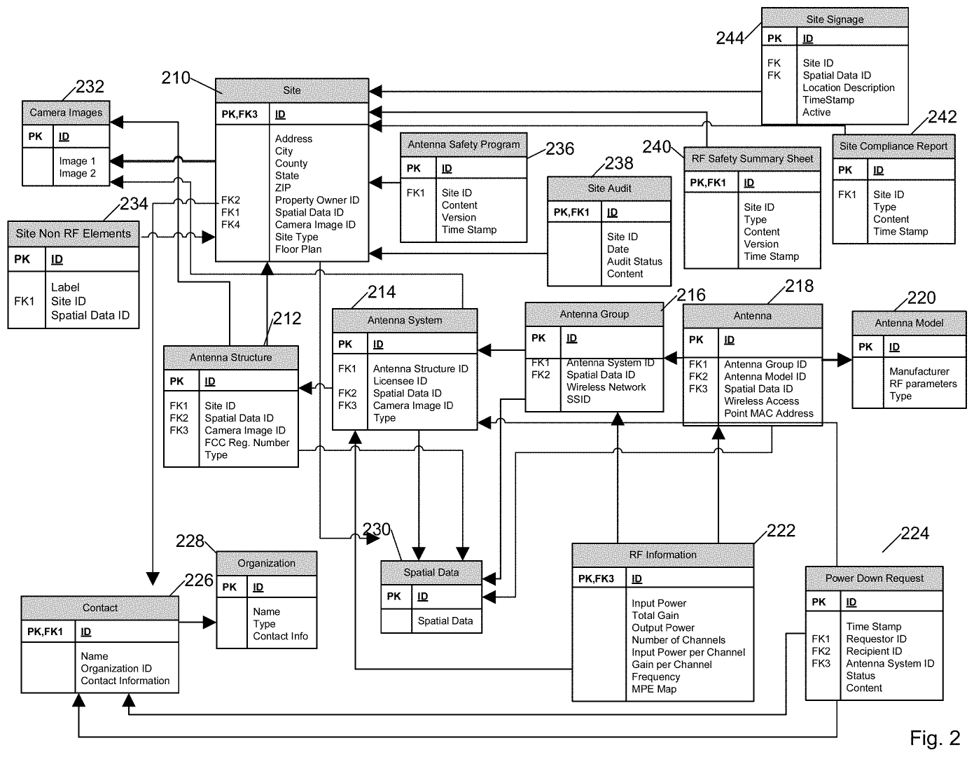

FIG. 2 is a database diagram or schema illustrating an example of an RF site database of a site's attributes. The database can be implemented on the database servers 124 of FIG. 1. In one embodiment this technology is built on the Microsoft N-tier Distributed Network Architecture (“DNA”), which separates the database, data access, business logic, and presentation layers to provide security, scalability and performance for high volume database applications. The database includes multiple tables which each have resident information. In the embodiment depicted in FIG. 2, a subset of the database data is presented to illustrate the key elements of the system.

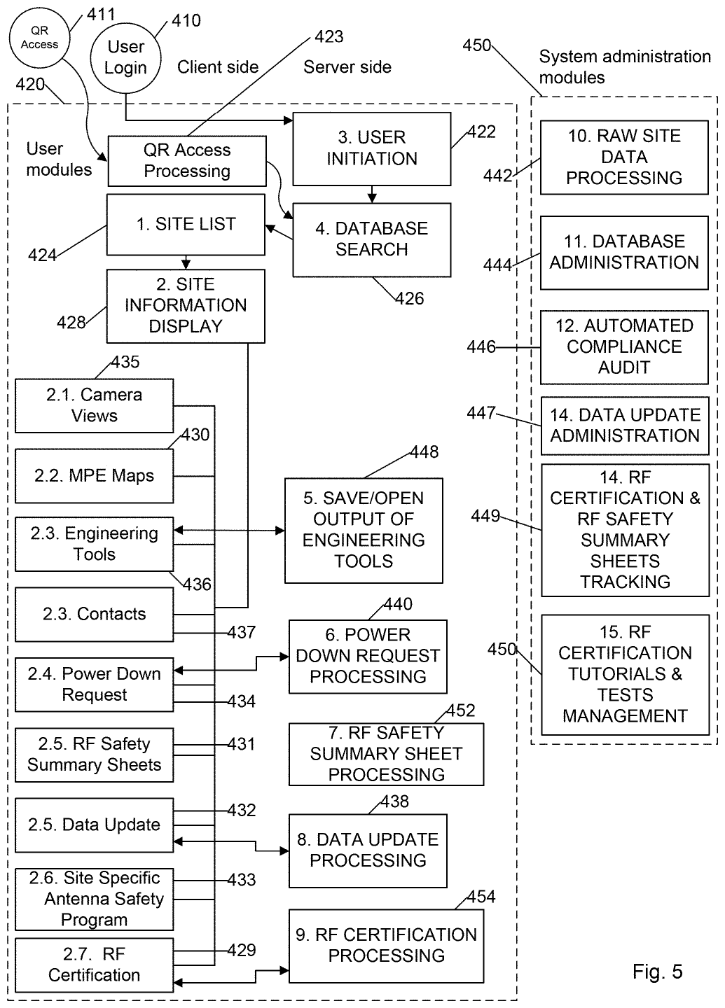

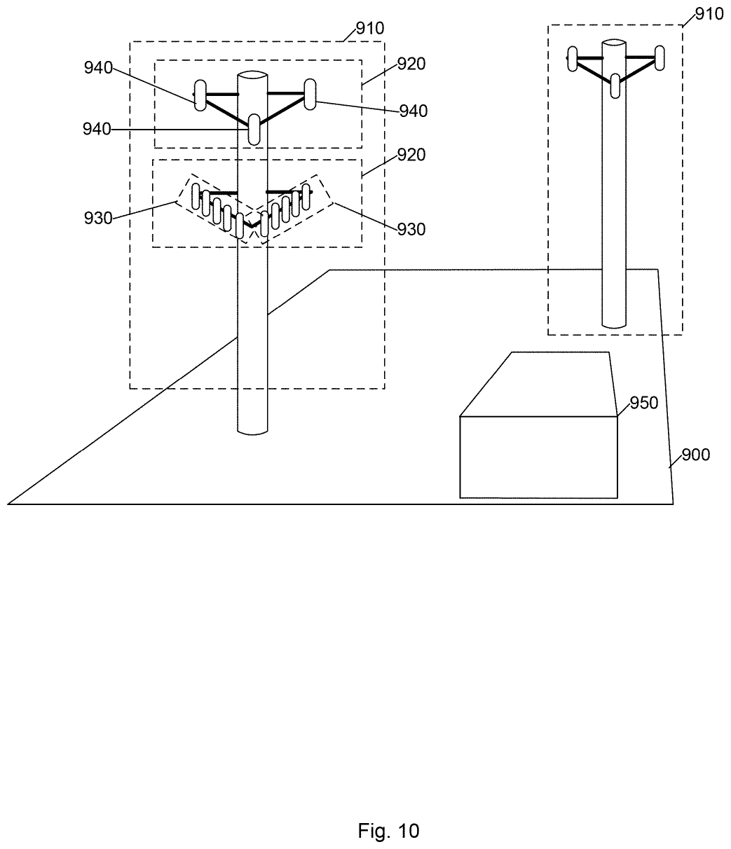

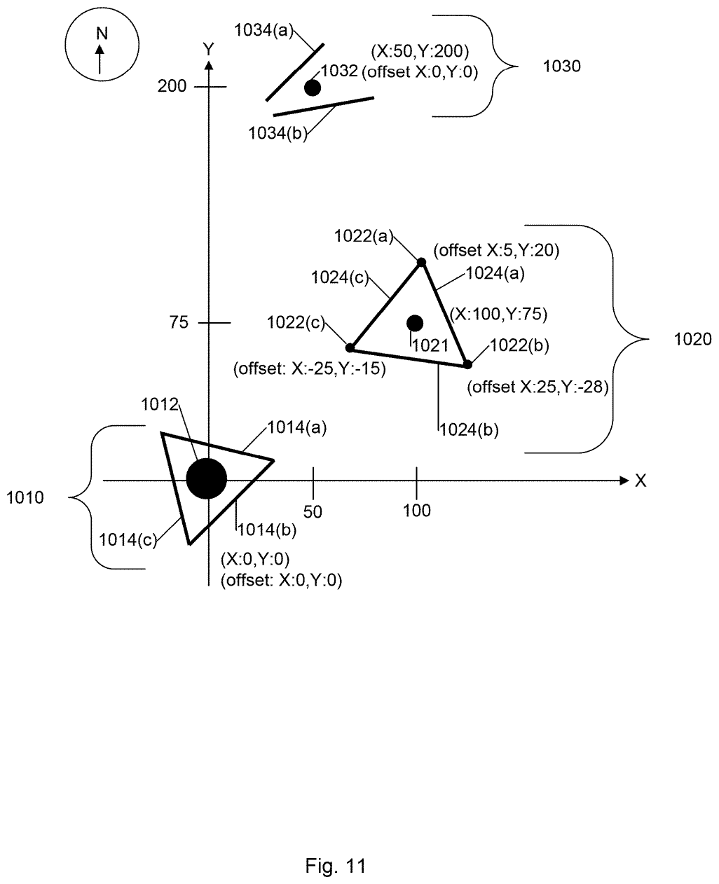

Site table 210 has following key attributes: ID which is a unique identifier for the site; site's address, including street Address, City, County, State and ZIP; Property Owner ID which is associated with the Contact table 226 and identifies a site's property owner; Spatial Data ID which is associated with the table Spatial Data 230 and identifies spatial data of the site, which will explained in connection with FIGS. 10 and 11; Camera Image ID which is associated with table Camera Image 232 and identifies camera images used by module 435 of FIG. 5, which will be explained later. Site Type identifies the type of site such as a commercial office building, hospital, medical center, higher education institute, hotel, convention center, park, sporting venue, airport, subway building, or dwelling.

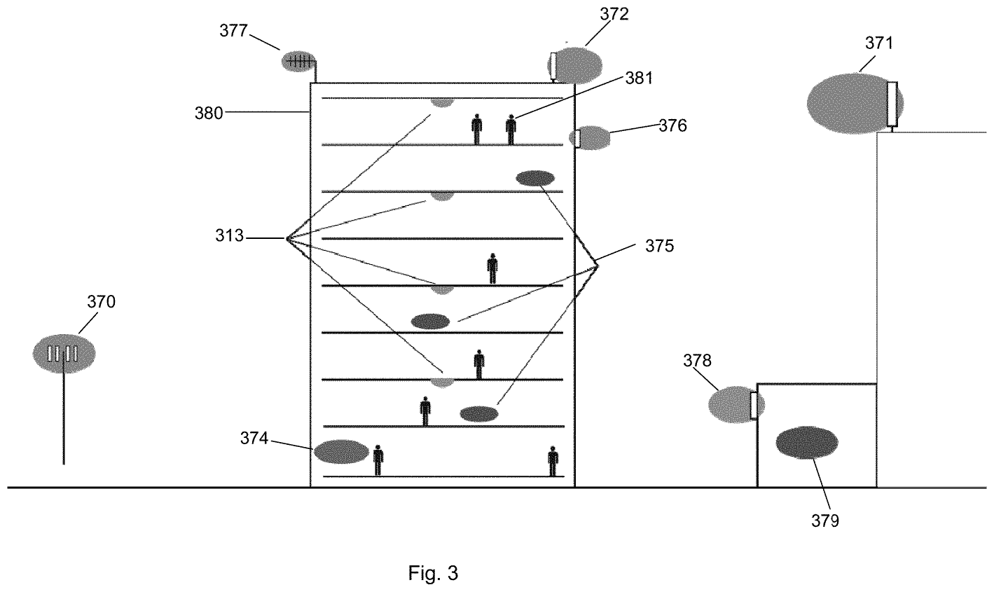

Site table 210 also includes the attribute Floor Plan. Floor Plan includes a site's physical layout, such as interior and exterior walls. The Floor Plan can also include a cross sectional view of a building such as the site plot map or floor plan of the building depicted in FIG. 3. In the example of a multi-floor building, Floor Plan includes the geometric boundaries of the entire building and each floor of the building, such as the length, width, and height. Floor Plan can include the length, width, and height within a 3-D environment. Floor Plan also associates with Antenna System 214 and relates the geometrical relationship between transmitters within a floor or outside the building in reference to the floor plan. Floor plan will be discussed in further detail below regarding FIG. 3.

Antenna Structure table 212 has following key attributes: unique ID; Site ID which is associated with the table Site 210 and identifies the site which antenna structure was assigned to; Spatial Data ID which is associated with the table Spatial Data 230 and identifies spatial data of the antenna structure, which will explained in connection with FIGS. 10 and 11; Camera Image ID which is associated with table Camera Image 232 and identifies camera images used by module 435 of FIG. 5, which will be explained later; FCC Reg. Number which is an unique number assigned to antenna structure by Federal Communications Commission; Type identifies antenna structure types such as electric pole or tower.

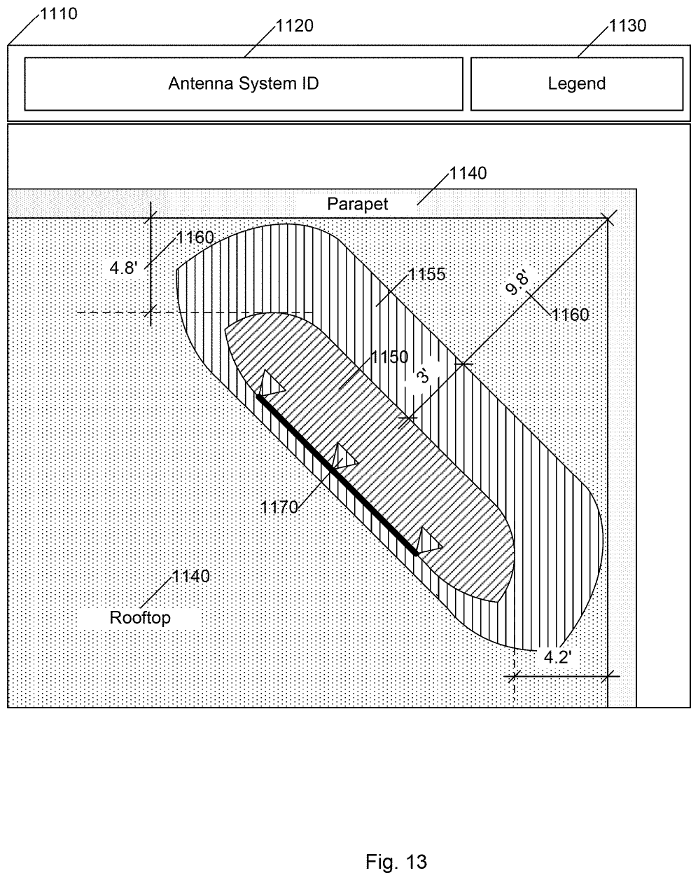

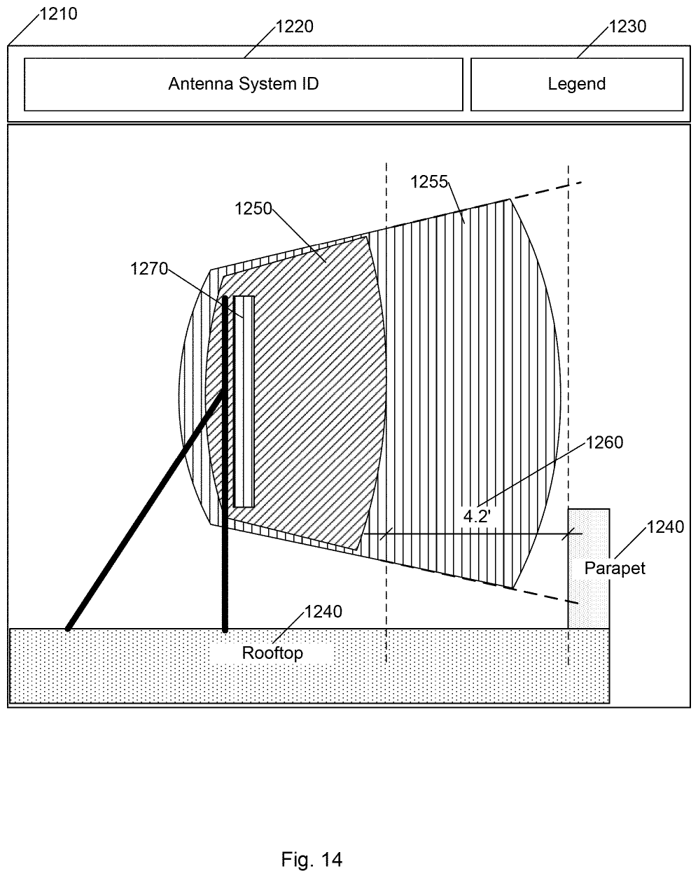

Antenna System table 214 has following key attributes: unique ID; Antenna Structure ID which is associated with the table Antenna Structure 212 and identifies the Antenna Structure which the Antenna System was assigned to; Licensee ID which is associated with the table Contact 226 and identifies the licensee such as Verizon Wireless or AT&T; Spatial Data ID which is associated with the table Spatial Data 230 and identifies spatial data of the antenna system, which will explained in connection with FIGS. 13 and 14; Camera Image ID which is associated with table Camera Image 232 and identifies camera images used by module 435 of FIG. 5; Type identifies the antenna system type such as array of panel antennas, a single antenna, a macrocell, a microcell, an inDAS, an outdoor distributed antenna system, an individual signal booster, a Wi-Fi hot spot, or any other type of transmitter.

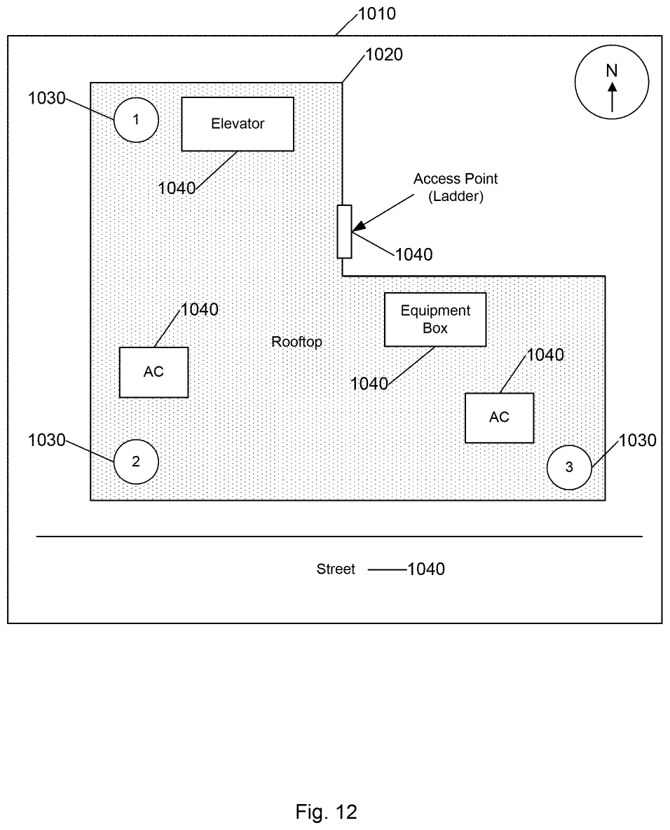

Antenna Group table 216 is used to join individual antennas into to group for the purpose of assigning RF Information. Antenna Group has following key attributes: unique ID, Antenna System ID which is associated with the Antenna System table 214 and identifies the Antenna System which antenna group was assigned to; Spatial Data ID which is associated with the table Spatial Data 230 and identifies spatial data of the antenna group, which will explained in connection with FIGS. 12 and 13; and Wireless Network SSID (service set identifier, or network name) which identifies the unique identifier of a wireless network and identifies wireless network type such as Wi-Fi. Wireless Network SSID is associated with Site table 210 which identifies the building that Wireless Network SSID is assigned to.

Antenna table 218 has following key attributes: unique ID; Antenna Group ID which can be associated with the Antenna Group 216, Antenna Model ID which is associated with the table Antenna Model 220 and identifies antenna model; Spatial Data ID which is associated with the table Spatial Data 230 and identifies spatial data of the antenna; Wireless Access Point MAC (media access point) address which identifies the unique identifier of a network interface device. Wireless Access Point MAC address is associated with RF Information table 222 which identifies the RF radiation specifications of a wireless access point device.

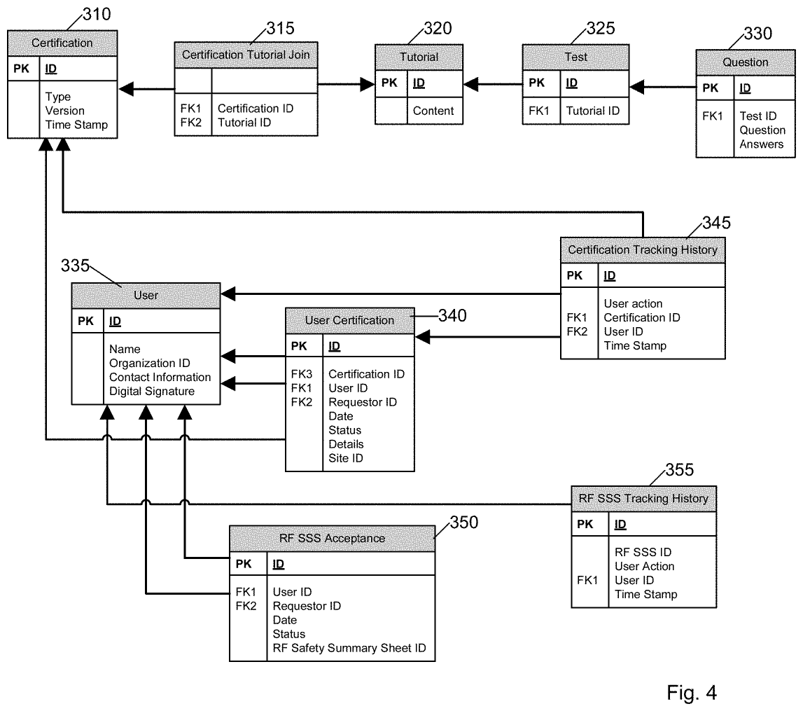

RF Information table 222 stores the information used to calculate power density levels used for creating MPE maps by module 430 of FIG. 4 and for the Engineering tools functionalities of module 436 of FIG. 4. Table has following key attributes: Input Power, Total Gain, Output Power, Number of Channels, Gain per Channel, Frequency and MPE Map.

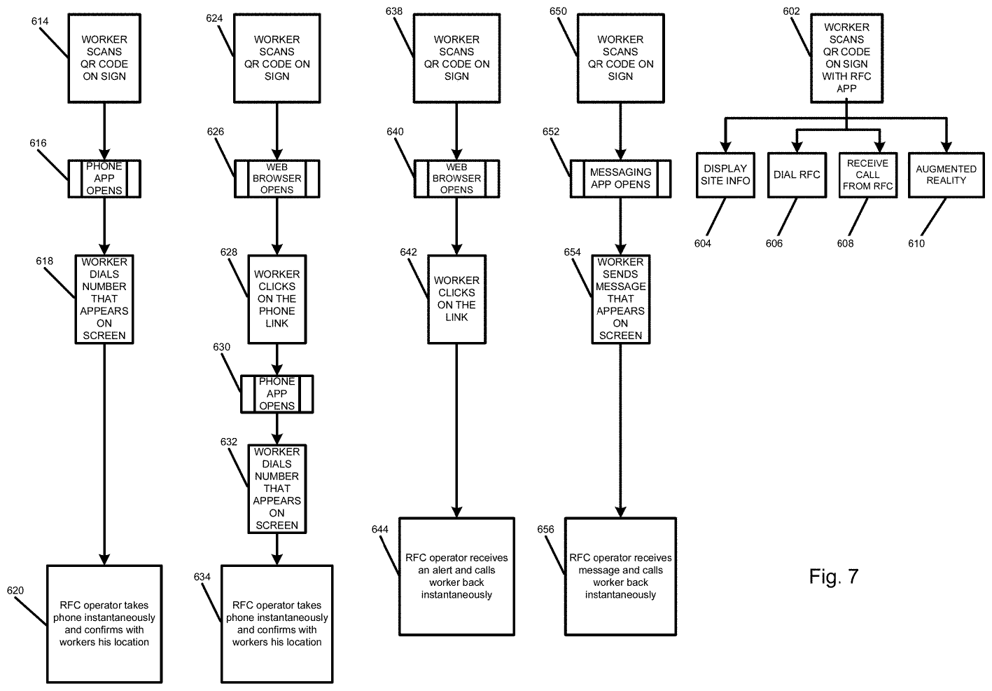

Table Power Down Request 224 is used to store information related to functionality of the module 434 of FIG. 4, which will be explained in connection with FIG. 7. Table has following key attributes: unique ID; Time Stamp which includes exact time and date in which power down was requested; Requestor ID which is associated with the table Contact 226 and identifies the person that requested the power down; Recipient ID which is associated with the table Contact 226 and identifies the recipient of the power down request; Antenna System ID which is associated with the table Antenna System 214 and identifies the antenna system which needs to be powered down; Status which indicates a current status of the power down request such as placed, received, or replied; Content which includes a detail information about the power down request.

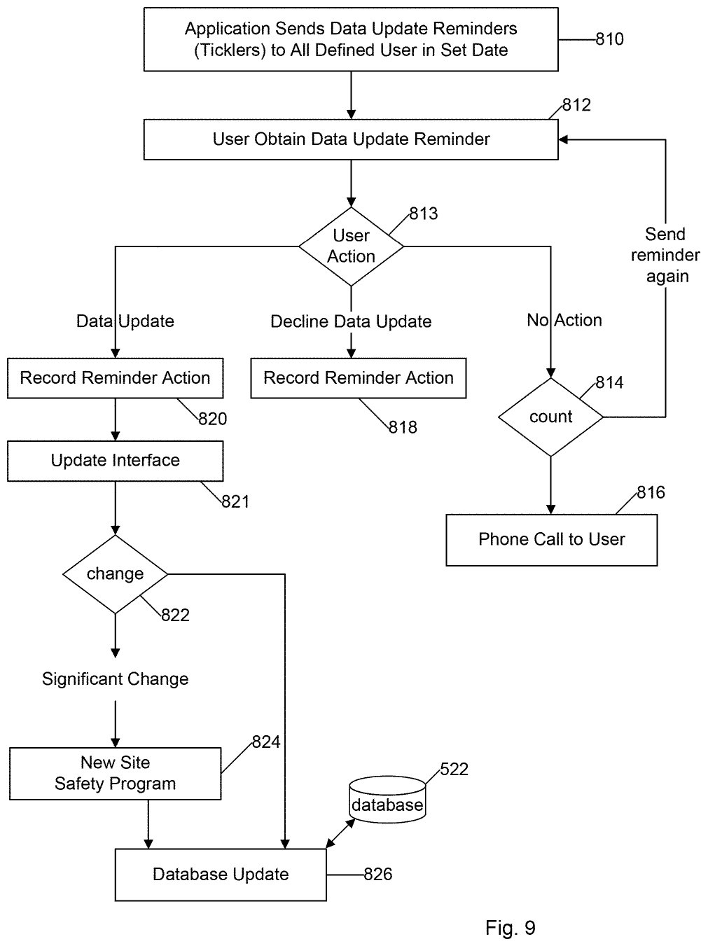

Table Site Non RF Elements 234 identifies the non-RF elements of the site such as equipment rooms, hatches, or fences. Table has following key attributes: unique ID; label which is displayed on various graphic representations of the site; Site ID which is associated with the table Site 210 and identifies the site which elements was assigned to; Spatial Data ID which is associated with the table Spatial Data 230 and identifies spatial data of the non-RF element, which will explained in connection with FIGS. 9, 10, 11 and 12;

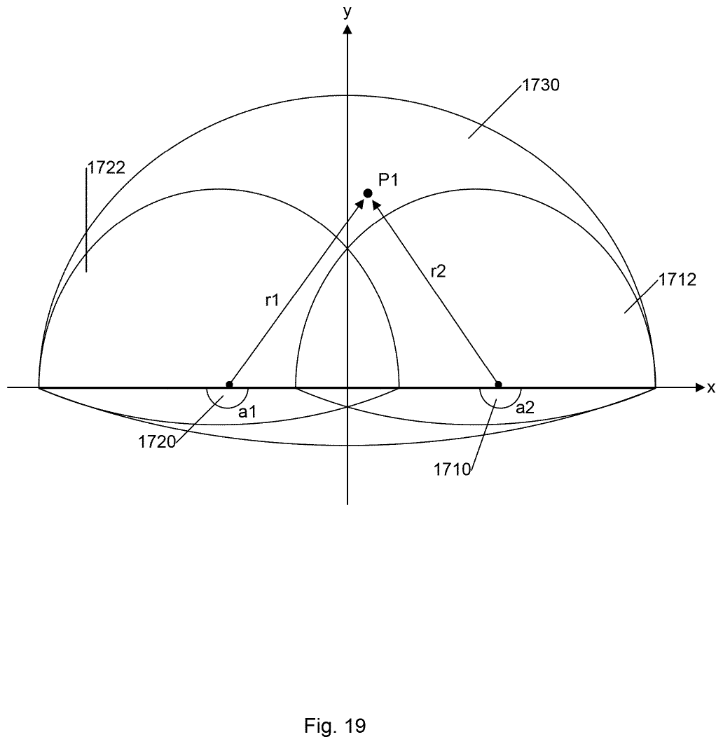

Antenna Safety Program table 236 stores site-specific antenna safety programs associated with the site and is related to module 433 of FIG. 4. Table has following key attributes: unique ID, Site ID which is associated with the table Site 210 and identifies the site which antenna safety program was assigned to; version number which is used to identify various version of the antenna safety program associated with the same site and will be explained in connection with FIG. 19; Time Stamp indicates the data and time when the version of antenna safety program was created.

Table Site Audit 238 stores the information related to site-specific RF compliance audits. Table has following key attributes: unique ID; Site ID which is associated with the table Site 210 and identifies the site which site audit was assigned to; Date which identifies the actual date of the audit; Audit Status identifies a compliance status of the site such as in compliance, or not in compliance; Content includes detailed information related to audit.

RF Safety Summary Sheet (site specific) table 240 stores RF safety summary sheets provided by system to workers, it is related to functionality of the module 431 of FIG. 5 and will be explained in connection with FIG. 14. Table has following key attributes: unique ID, Site ID which is associated with the table Site 210 and identifies the site which RF safety summary sheet was assigned to; Type indicates type of the sheet such as trained worker or general worker; Content attributes includes a content of the sheet such as camera images, MPE maps, or site contact information; Version stores the identifier of the version of RF summary safety sheet for future reference; Time Stamp stores the date and time when RF safety summary sheet was created.

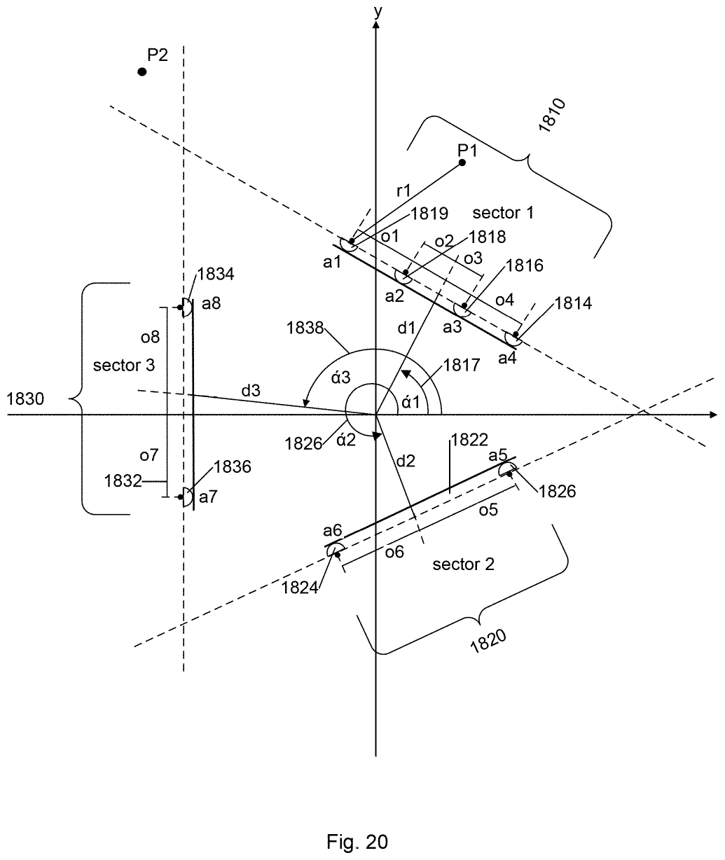

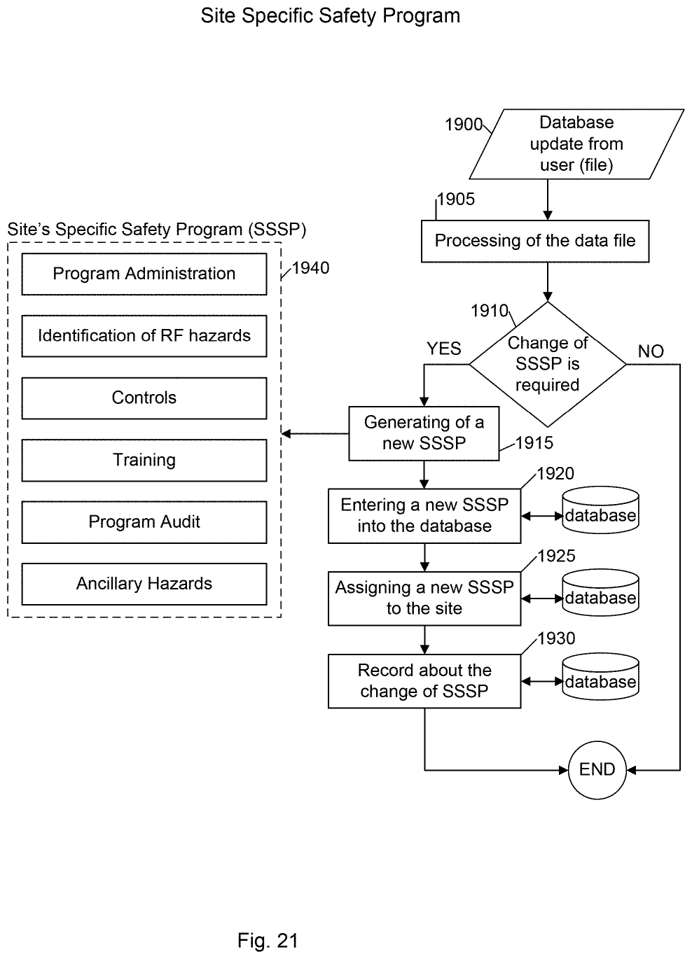

Site Compliance Report table 242 includes the information related to function of module 446 of FIG. 5 and will be explained in connection to FIGS. 20 and 21. Table has following key attributes: unique ID; Site ID which is associated with the table Site 210 and identifies the site which compliance audit was assigned to; audit Type such as monthly or annual; Content which in details describes compliance status of the site; Time Stamp stores the date and time when compliance report sheet was created.

Site Signage table 244 stores the information related to the warning signs associated with the site and is related to the QR access processing module 423 of FIG. 4. Table 244 can include: unique ID, Site ID which is associated with the table Site 210 and identifies the site which sign was assigned to; Spatial Data ID which is associated with the table Spatial Data 230 and identifies the exact position of the sign relative to a site; Location Description which is a description of the sign location and mounting, Time Stamp indicates the date and time when the sign was placed on sit; Active indication, which indicates if the sign is currently active/placed on the site.

FIG. 3 is an example of a cross sectional or side view site plot map of a building 380 and surrounding structures illustrating a graphic representation of multiple sources of RF radiation. Building 380 may be a structure such as a commercial office building, hospital, medical center, higher education institute, hotel, convention center, park, sporting venue, airport, or a subway building. In some instances, building 380 is a dwelling. The floor plan may be provided by a public entity such as a city administration, by a private entity such as a building owner, or created during a site survey. In some embodiments, floor plans are provided in a uniform format. A person within building 380, such as person 381, may be subject to multiple sources of RF radiation. RF radiation may be transmitted by outdoor transmitters (outdoor relative to building 380) such as a rooftop antenna 371, a rooftop antenna 372, a facade antenna 376, a donor DAS antenna 377, a pico cell 378, a public Wi-Fi hot spot 379, and/or cell tower 370. In addition, RF radiation may be transmitted by an indoor transmitter such as an inDAS 373, a cell signal booster 374, and/or floor Wi-Fi hot spot 375.

inDAS 373 may be an indoor distributed antenna system of spatially separated nodes connected to a common source such as rooftop antenna 371, rooftop antenna 372, or cell tower 370. Donor DAS 377 may be an outdoor distributed antenna system of spatially separated nodes connected to a common source such as rooftop antenna 371, rooftop antenna 372, or cell tower 370. Both inDAS 373 and donor DAS 377 may split the transmitted power from an antenna such as rooftop antenna 372 among several antenna elements so as to provide coverage over an area but with reduced total power and improved reliability. Thus, both inDAS 373 and donor DAS 377 may be used to increase wireless signal within building 380.

Floor Plan of Site table 210 of FIG. 2 includes geometric data of building 380, such as the length, width, and height of each floor, the entire building and the locations of interior walls. Floor Plan can include the location of certain areas of each floor of a building, such as offices, cubicles, conference rooms, cafeterias, and storage rooms. Floor Plan can include the location of entrances and exits of each floor of a building, such as main entrance doors, side entrance doors, fire escape, and emergency exits. In addition, Floor Plan identifies certain boundaries of building 380, such as a North wall, a South wall, a West wall, a East wall, a building base, and a building ceiling. Furthermore, Floor Plan identifies boundaries of each floor, such as a floor base and a floor ceiling. Each boundary can be defined relative to defined X-Y-Z coordinate.

Spatial Data ID of Antenna System table 214 of FIG. 2 includes spatial data of each transmitter emitting radiation to building 380. Spatial data of each transmitter may be identified by GPS coordinates. Floor Plan and Spatial Data ID may reference one another to generate a coordinate system where each transmitter has a relative position to a reference point of building 380. For instance, the Southwest corner may be defined as the origin or reference point for the X, Y, and Z coordinates, and each transmitter may be X-offset, Y-offset, and/or Z-offset from the Southwest corner. Transmitters offset in the Z direction from the reference point can be identified by the floor the transmitter is located in due to the floor height data captured in Floor Plan. Outdoor transmitters, such as rooftop antenna 371 may also have offset coordinates from a reference point.

In certain situations, a first responder may need to know the physical location of a transmitter within a building. For example, the first responder, or a first responder dispatch center, may request from the system, the location presence of a transmitter within the building. In some instances, the first responder or dispatch center may have access to the database of the system and can check the database for transmitters within the building. In other instances, a system administrator may check the database and relay back to the first responder or dispatch center the physical locations of the transmitters. In some embodiments, the system or system administrator can provide coordinates of the transmitter within an accuracy of 140 feet or less.

In some embodiments, the first responder or the dispatch center has access to a floor plan of a building that contains the physical locations of all transmitters within that building. The floor plan may also include the physical locations of any antennas located outside of the building. In certain embodiments, the first responder or the dispatch center may retrieve the floor plan of the building from the database via the internet.

A first responder, such as a policeman, may access the floor plan during an emergency situation such as a terrorist attack, a hostage situation, a fire, or an earthquake. The floor plan may allow the policeman to identify the location of office cubicles, offices, conference rooms, cafeterias, storage rooms, and other locations in the building where office workers may be located. In addition, the floor plan may allow the policeman to identify the location of emergency exits.

A database of exact locations of all site transmitters, including cell antenna unique identification, or WLAN's SSID and MAC in conjunction with the database of buildings floorplans can be used for an indoor positioning system. In one embodiment, the indoor positioning system utilizes spatial data information from the 3-D X,Y,Z coordinate system disclosed above. Actual positions of each transmitter can be determined by using one or more techniques such as triangulation or multilateration. Triangulation can be used to determine a transmitter's actual position by knowing the range of a single transmitter and its relative location to other transmitters. In addition, in particular embodiments, the indoor positioning system references Floor Plan of Site table 210 to determine the 2-D location of each transmitter relative to a floor of a building or site. Other indoor positioning methods that do not rely on positions and characteristics of RF transmitters may be also used as a part of hybrid positioning solution or as a sole method.

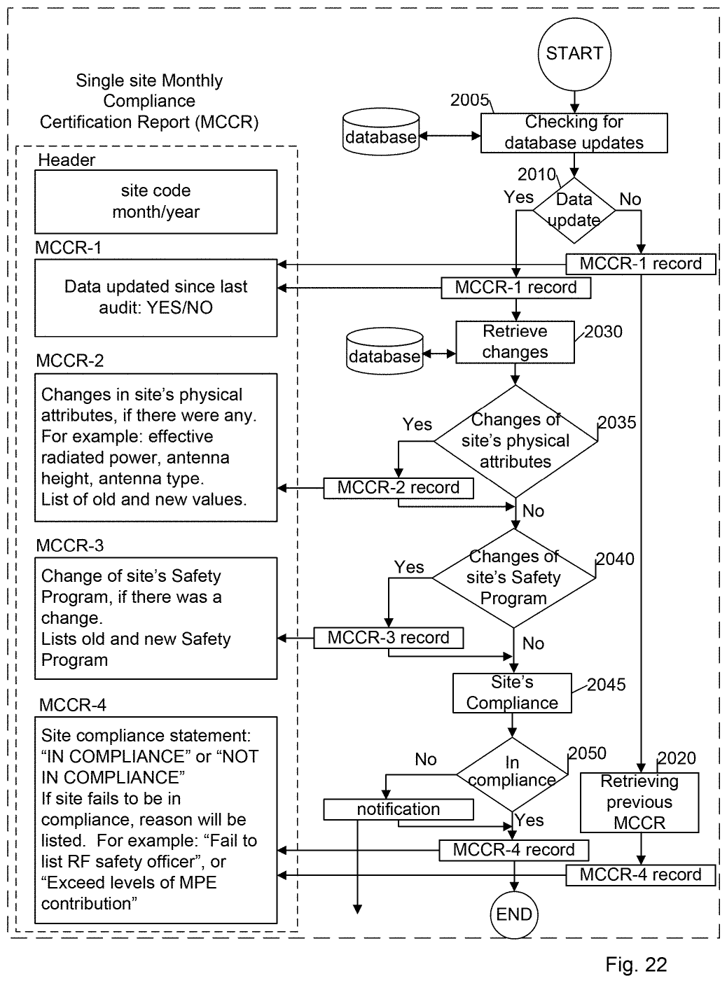

FIG. 4 is a database diagram or schema illustrating the attributes related to RF Certification and (site specific) RF safety summary sheets. Tables can be implemented on the database server 124 of FIG. 1. The schema includes a tables and data related to functionalities of modules 431 and 429 of FIG. 4. Additionally, the tables can include a data described later in connection with FIGS. 22-26.

Table Certification 310 includes a various versions of the RF Certification and it is used for a new system user who requires RF certification, worker, or contractor company. Table has following key attributes: unique ID; Type which indicates certification type such as Property Owner Representative RF certification, or Trained Worker RF certification; Version which indicates a version of the certification and is used for the future reference; Time stamp is a date and time when the certification was created.

Table Tutorial 320 includes various tutorials that can be assigned to multiple certifications. A table has unique ID and attributes Content which stores actual content of the certification tutorial. Multiple tutorials can be associated with the multiple certification using table Certification Tutorial Join 315. Each tutorial of the certification is followed by an appropriate test which includes various questions. Table Question 330 includes test questions and the possible answers with indication of the correct answer. The table Question is associated with table Test 325 which is associated with the table Tutorial 320.

Table User Certification 340 stores a history of certifications taken by system users. Table has following attributes: unique ID; Certification ID which is associated with the table Certification 310 and identifies the certification; User ID which is associated with the table User 335 and identifies the user who took certification; Requestor ID which is associated with the table Users 335 and identifies the requestor of the certification; Date which indicated the date when certification was taken; Status indicates status of the certification such as completed or uncompleted; Details includes certification test results; Site ID is associated with the Site table 210 of FIG. 2 and indicates the site if the certification was site-specific.

Table Certification Tracking History is used to provide a detail view of the steps taken by user during the certification, including user's answers to the test questions and tracking of the time user spent on various sections of the certification. The table has following key attributes: unique ID; User action that stores each step user takes during the certification; Certification ID which is associated with the table 310 and identifies certification; User ID which I associated with the table User 335 and identifies the user; Time Stamp that store exact date and time per user action.

Table RF SSS Acceptance 350 is used to track user's acceptance of the site-specific RF safety summary sheets. Table has following key attributes: unique ID; User ID which is associated with the table User 335 and identified the user who accepted RF safety summary sheet; Requestor ID which is associated with table User 335 and identifies the user who requested acceptance of the RF safety summary sheet; Date indicates the day when the RF safety summary sheet was acknowledged, Status indicated the status of the request such as requested or acknowledged; RF Safety Summary Sheet ID which is associated with the table 240 of FIG. 2 and indicates the RF safety summary sheet.

Table RF SSS Tracking History is used for tracking the user's actions related to acceptance of RF safety summary sheets. The table has following key attributes: unique ID; User action that stores each step user takes during the acceptance of the RF safety summary sheet; RF SSS ID which is associated with the table 240 of FIG. 2 and identifies RF safety summary sheet; User ID which I associated with the table User 335 and identifies the user; Time Stamp that store exact date and time per user action.

FIG. 5 is a functional block diagram illustrating the functions or modules of one embodiment of the System 100 of FIG. 1. The System includes user modules 420 and system administration modules 450. The user modules 420 provide the operational functionality of the System and the system administration modules provide the administration functionality. The user modules are divided into client side modules and server side modules. The client side modules generally provide the interface functionality for the user interaction. In one embodiment the client side modules run on a remote user computer FIG. 1 110(a-c) and provides a graphic interface to users. The Server side modules run on the server side on the web/application server FIG. 1 120, and interact with database servers 124 and send output to client side.

On the server side the user modules include a user initiation module 422, a database search module 426, a power down request processing module 440, a save/open output of engineering tools module 448, data update processing module 438, RF safety summary sheet processing module 452 and RF certification processing module 454. On the user side the user modules include a site search module 424, a site information display module (sometimes referred to as building information display module) 428, a camera view module 435, an MPE maps module 430, an engineering tools module 436, a contacts module 437, a power down request module 434, a RF Summary Sheets module 431, a data update module 432, a site specific safety program module (sometimes referred to as building specific safety program module) 433, and a RF certification module 429

The user initiation module 422 implements the user logon function (410) including determining whether the user has authorization to use the System and determining what rights the particular user has. This can include providing an initial page (e.g., a web page) that can be accessed as an initial entry point for accessing the system.

The QR accessing module (or a machine readable indicia accessing module) 423 implements the QR access process which, in one embodiment, is initiated by, for example, a module residing and operating on a user device. This process can provide a simplified access process to a site which is identified by machine readable indicia which is read by the user device, for example, a cellular telephone. This process is described in more detail in connection with FIG. 7.

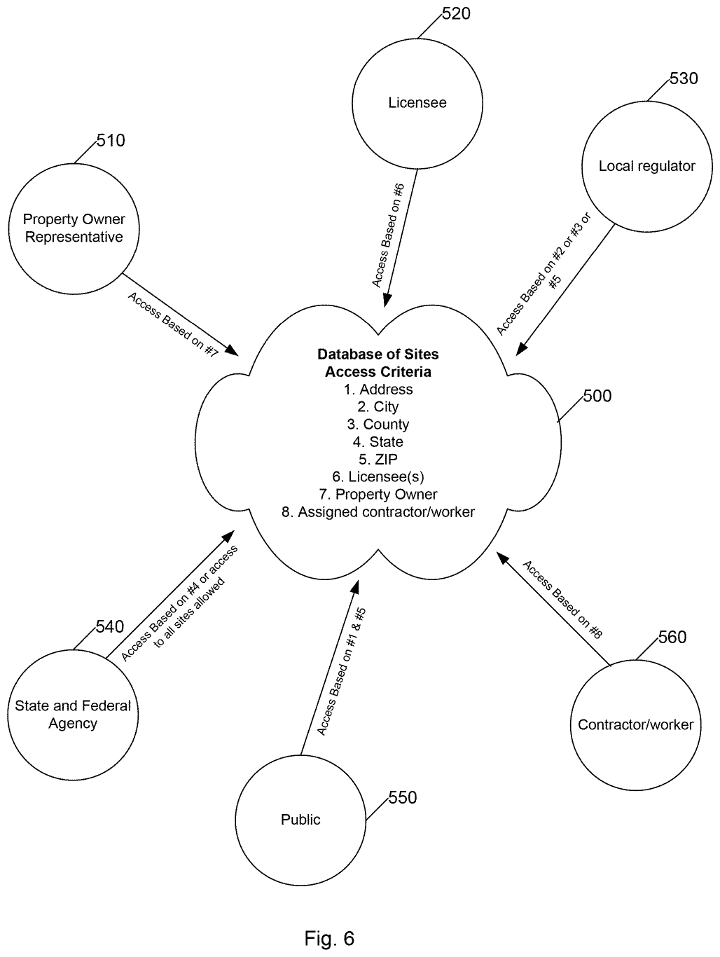

Database Search module 426 searches the database of the sites based on user's role in the system and will be explained in connection with FIG. 6. The database search module 426 resides on web/application servers 120 and interacts with the database servers 124 of FIG. 1. The database search module 426 searches the data base using the various search criteria and provides the results to the site list module 424. Site list module 424 provides user with the list of the sites he is authorized to view.

The site information display module (or building information display module) 428 provides the user with information about a specific site. In one embodiment, site information display module shows the user a floor plan of a floor of a building of a specific site. In one embodiment, the site information display module shows the user the site top preview, the geographic map preview, the site panoramic view or a slideshow of the site's camera views and site information. The site top preview is generated from data in the database. In one embodiment the system creates a site top and side preview map and shows site plot map—a graphic representation of all site elements with the MPE maps. The geographic map preview can be generated using web services or stored images and displays sites on a geographic map. The module allows the user to click on a zoom button or the image itself and a zoomed map view is displayed with a dot that represents the site location. In one embodiment in order to generate the site panoramic view or slideshow of the site's camera views, the camera module 435 loads an external panoramic image of the site to a system component allowing a simulation of the panoramic view and zoom, or slideshow of the site's camera views. For the site information the module displays site information which includes the items set forth in the site table of FIG. 2 (210). The module can vary the site information presented based on the type of user or rights of a user as set forth in the system user database. In one embodiment the system creates a floorplan view with graphic representation of all transmitters and corresponding MPE maps.

From the site information display module 428 the user can choose to use the functions of the camera view module 435, the MPE map display module 430, the data update module 432, the power down request module 434, the engineering tools module 436, the contacts module 437, the RF Safety Summary Sheets module 431 and the site specific antenna safety program module 433. A user can also enter the RF certification module 429. However, this module can also be entered or accessed directly from the user initiation module 422. The site specific program module displays a site specific safety program to a user. This module also updates the site specific safety program when changes are made to a site. The functionality of this module will be explained in connection with FIG. 20.

The camera views module 435 loads and displays multiple types of camera site views. In one embodiment these views include far and close view. These views are retrieved from the data structure shown in FIG. 2.

The MPE map display module 430 displays the sites transmitters showing all the site's elements and the associated MPE maps. FIGS. 11 and 12 provide examples of the MPE map views. In one embodiment, this enables any worker or individual visiting any site in the United States to see the RF radiation pattern maps. These RF pattern maps can be updated on a daily basis and are an integral part of the System's compliance and safety solution.

The data update module 432 allows an authorized user (for example a representative of an organization that operates one or more sites) to edit data of the site antennas that are associated with the authorized user. The data update module also receives data from the wireless telecommunication company who owns the antenna. The module sends the edited data to the data update processing module 438. This data update processing is explained in more detail with FIG. 9 below. The data update processing module provides a site element preview map with selectable antennae structures.

In one embodiment, data update module 432 allows a system to update a floor plan of a building. The system can update the floor plan for physical changes made to certain areas of a floor of a building, such as offices, cubicles, conference rooms, cafeterias, and storage rooms. The system can also update the floor plan for changes made to the location of entrances and exits of each floor of a building, such as main entrance doors, side entrance doors, fire escape, and emergency exits. In addition, the system can update the floor plan for repositioning of transmitters such as inDAS, individual signal boosters, and WLAN networks.

In one embodiment a click on an antenna structure displays the following information: antenna label, sector label, antenna structure label, antenna frequency (editable), antenna input power (editable), antenna type (editable), and antenna model (editable). A click on the antennae structure yields an antennae structure zoom view with various antennas each having a link to further screens. A click on a particular antennae yields information including the information set forth in FIG. 2. The data update processing module communicates with the system administration modules 450. The data update module 432 provides the user with the ability to edit editable fields and send updates to the administrator.

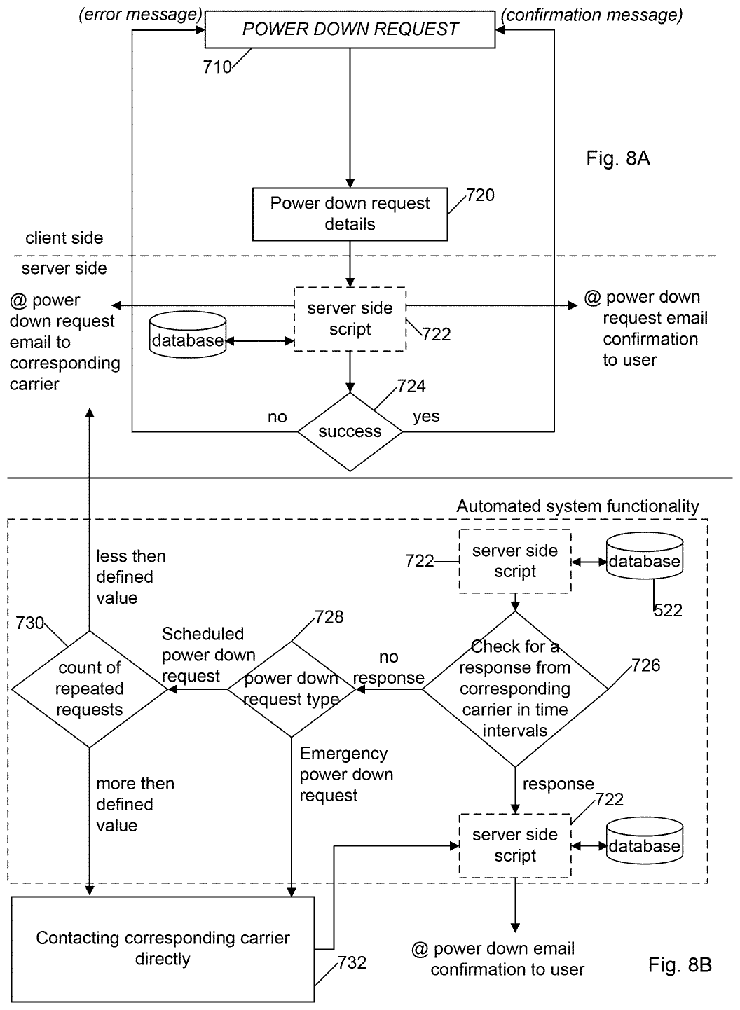

The user can also move from the site information display module 428 to the power down request module 434. The power down request module allows the user to request that a particular site's or antenna system at a sites power to be reduced or turned off. The power down request module 434 communicates with the power down request processing module 440. The power down module allows the user to send power down requests for one or multiple antenna system from selected sites. The power down request is sent by email to the broadcaster (operator of the antenna) and a copy of that e-mail to the system administrator. The power down processing module 440 creates a database entry about the power down request and sends confirmation to the user. The scheduled power down request allows the user to send scheduled power down request with information including reason for power down request, selected antenna structures, and date and duration in hours. The power down request has both a manual and automated power down function. A more detailed description of the functioning of the power down request processing module is set forth in connection with FIG. 8 below.

The engineering tools module 436 generates and provides an MPE map based on utilizing dynamic resident database information, and modified data. Utilizing the dynamic resident database information the engineering tools module 436 calculates power densities for antennas in the database including calculations for intermodulation, isolation and creation of a hypothetical site called a “try-out” site. For the MPE map, the user can select any antennae from the site to view all information about the antennae. The user can manipulate some of the data to see how it affects the MPE maps. For intermodulation the module calculates the intermodulation between two selected antennas. For isolation the module calculates the isolation between the two selected antennas. The user can create try-out sites by placing new antennas into the site to create a preview of MPE maps or calculate intermodulation and isolation. Intermodulation and isolation studies predict possible interference of radio frequencies transmitted from different antennas and provide important information about the isolation levels required for a compatible site environment.

The contacts module 437 displays to the user contact information including transmitter licensee or owner, site property owner representative and city or municipalities. In one embodiment of a contact contains the following fields: company name, person name, title, phone, fax, cell phone, e-mail, address, city, zip and state.

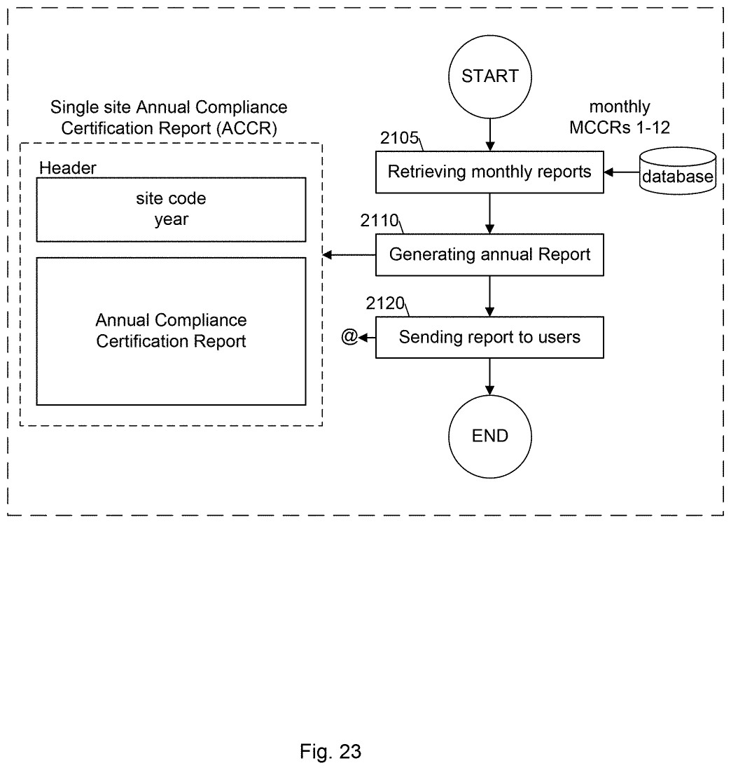

The RF Safety Summary Sheet module 431 provides the user the ability to review and print Site-specific RF safety summary sheets. The Site Specific Safety Summary Sheet can be provided in two versions. A first version, intended for RF trained workers (explained in more detail below), includes site-specific information for work inside the areas where power density exceeds MPE limits for general, untrained workers. A second version includes site-specific information for work outside the areas where power density exceeded MPE limits and is intended for use by general, untrained workers. If only a black and white printer is available, the module 431 creates a print output suitable for black and white print showing the graphic representation of MPE maps as crosshatched areas. The RF safety summary sheet processing module 452 provides functionally related to sending the request for accepting the RF safety summary sheet to the user and tracking of the request. All of these processes will be explained in more detail with FIG. 23.

The RF certification module 429 and RF certification processing modules provide general and site specific training and certification and tracks the same. The module also provides functionality to ensure that RF certification is completed before providing users with the Site Specific RF safety summary sheet. Furthermore the module allows a user to invite others (e.g., contractor companies) to obtain a company RF Certification. Once a company becomes certified, they may manage their employees and provide them with a trained worker RF Certification via the module, and/or to issue the Site-Specific RF safety summary sheet. Furthermore the system allows workers or contractor companies to complete a general RF certification by their own request. The operation and functionality of the RF certification module 429 is described further below in connection with FIGS. 22-26

The system administration modules 450 include a raw site data processing module 442, a database administration module 444, an automated compliance audit module 446, a data update administration module 447, RF certification & RF safety summary sheet tracking module 449, and RF certification tutorials and test management module 450. Data update administration module 447 sends reminders through notifying a defined contact to update actual attributes of the site. Periodic updates are necessary as there are frequent changes to the actual attributes of sites. The automated compliance audit module 446 provides functionality for database audits. It audits the sites which are controlled by the System on a monthly and annual basis to confirm that they are in compliance with International, Federal and State regulations, for example IEEE, FCC, and California OSHA. In one embodiment the data update administration module handles sending requests for data updates to the users (out′), and when the user responds (in) it evaluates updates.

The database administration module 444 includes the functions to manage the application users, manage site data, manage power down requests (set forth in FIG. 8A, 7B), and track application usage. In one embodiment the raw site data processing module 442 performs functions including converting raw data files into the format required by the database structure as seen in FIGS. 2 and 3, and checking the quality of data.

The RF Certification & RF Safety Summary Sheets Tracking module 449 includes functionality that allows system administrator to track all system activities related to RF Certification and providing RF safety summary sheets. System, administrator can review all requests for RF Certification, all attempts to complete RF Certification tutorials and tests including failed, and users' acknowledgements of RF Certifications. System administrator can further review in details user's RF Certification test results with visibility into every question presented and user's answer. System administrator can further review all requests for providing RF safety summary sheets to the worker; all accepted requests, including the user's acknowledgement of the RF safety summary sheets.

The RF Certification Tutorial & Test Management module 450 provides the system administrator with ability to create various RF Certifications types based on the requirements. The System administrator can create tutorials and tests and assign them to the RF Certifications. The module further provides functionality to measure performance of the various RF Certifications using the tracking data retrieved from previous user's attempts to complete RF Certification.

FIG. 6 is a block diagram illustrating the controlled access database based on user's role in the system. The described process can be implemented by the corresponding modules 410, 422, 426 depicted in FIG. 5. The database 500 can be implemented as the database servers 124 in FIG. 1 which can include the site database depicted in FIG. 2. The use of the terms “site” and “sites” in this description refers to the representations of the sites in the database.

Database 500 includes various attributes that can be used for retrieving search query results based upon the users' roles in the system. A property owner's representative (510) can view existing sites on the properties he represents; search criteria #7 is used—system displays all sites where the current user—Property Owner's Representative—was associated with the site attribute “property owner.” A licensee or network operator (520) can view existing and proposed sites with his antenna system on it; search criteria #6 is used—the system displays all sites where the current user—Licensee—was associated with the antenna system property “licensee” and those antenna system were associated with the sites.

A local regulator (e.g., a government official) (530) can view existing and proposed sites within his jurisdiction; search criteria #2 or #3 is used—the system displays all sites with the matching city, county, or ZIP code. For example city government can view all sites where the database attribute city equals the government's city. Members of the public (550) can view existing and proposed sites within a defined radius from their residence; search criteria #1 and #54 is used. The System converts the user's defined location into the GPS location and displays sites within the defined radius from that location. Contractor companies or individual workers (560) can view existing sites that they were assigned to work on. This access type is created using functionality of the RF Safety Summary Sheet module 431 and RF Certification module 429 of FIG. 4.

Members of State and Federal agencies (540) can view sites based on their jurisdiction on the state level (State Agencies) or have access to all site within the USA (Federal Agencies); search criteria #4 is used—site attribute “state”. For example, first responders such as police and fire fighters are provided access to the data base on a state or local level. In the embodiment where access is initiated by the user's access device scanning a machine readable indicia, the user's device would also identify the user to the System automatically (e.g., by provider an identifier of the access device registered to the user or information which identifies the user or both) or the user can log into the system.

The system further allows larger organizations, such as wireless service providers, to manage their access to the database according to their internal organization structure. For example the system allows them to create multiple user accounts for their representatives and assign them access to sites by their region, state or county.

In one embodiment, the interface with the site information is presented as a site top preview map—a site plot map—with all the site's elements based on the database data. Site top preview will be explained in details with connection to FIG. 10 Antenna structure pop-up window shows detailed information about the antenna including MPE horizontal view with buttons allowing the user to switch between antenna arrays, MPE map vertical view with buttons allowing the user to switch between antenna sectors, antenna structure camera views including both standard and close view options, and antenna structure information. In one embodiment antenna structure information can include the antenna structure type, latitude/longitude of the antenna structure, list of antenna arrays with labels and elevations, list of antenna sectors for all antenna arrays with labels and azimuths, and list of all antenna for one antenna sector with label, frequency, power, antenna type, and model.

In one embodiment, the interface with the site information is presented as a floorplan with a graphic representation of all sources of RF radiation and MPE maps. In one embodiment, the interface with the site information is presented as a 3-dimensional model of a building with a graphic representation of all sources of RF radiation and MPE maps.

In one embodiment, the site information module 428 also allows the user to filter sites by power line types (high power lines, low power lines, restricted), print information related to RF safety for specific pole numbers, and create an interactive map. The interactive map function allows the user to ‘move’ along the power lines on an interactive map to locate another site on the same power line. The interactive map displays clickable arrows in the direction of the power line, a click on these arrows moves toward the location. The sites are shown by a dot; a click on a site dot displays information about the site.

FIG. 7 is a flow diagram of one embodiment of the process implemented by the QR access module 423 of FIG. 5. This process can provide a simplified access process to information for a site which is identified by machine readable indicia which is read by a user device, for example, a cellular telephone. The machine readable indicia can be, for example, a matrix barcode (such as a QR code), a two-dimensional barcode, an RFID tag or receiving a wireless transmission, such as a blue tooth transmission. The references to machine readable indicia herein frequently reference a QR code, it should be understood that the invention is not limited that specific type of indicia. The machine readable indicia can be provided on a sign warning of the RFR radiation hazard (a warning sign) which can be located at or near to the access points of the site. For example, for sites which are buildings, the machine readable indicia can be located at one or more of the doors providing entry into the building. Alternative locations can also be used for the machine readable indicia. Scanning or reading the machine readable indicia provides the user device with the information which identifies the site and the location of the sign at the site. For example, the machine readable indicia can provide the ID of the site (see FIG. 2, element 210) and the identification of the specific sign at the sight or another identification of the site such as its address and the location of the sign. The location of the sign can be important, for example, for sites with multiple antennas.

Referring to FIG. 7, an embodiment of the operation of the QR access processing module 423 will be described. Functions or steps not explicitly described as being performed by a module are performed by the QR processing module 423. At a step 602, a user scans the QR code (or reads another machine readable indicia) using a wireless mobile communication device (e.g., such as a smart phone, a tablet or another device having the capability to scan or read the machine readable indicia) which has specialized software running on the device. The software running on the phone can be configured to immediately obtain and display the site information for that location from the site information display module 428 as represented by step 604. For example, the QR processing module can provide the identifier of the site (from the QR code) to the database search module 426 to obtain the site information. Alternatively, at a step 606 the software can cause the device to initiate a telephone call with the predetermined telephone number of a call center supported by trained safety specialists. These specialists can then assist the user. The telephone number called can indicate the site. Alternatively, at a step 608 the user device sends a message including the telephone number of the device (e.g., by a text, email or other communication protocol) in response to which an operator at the phone center calls the user's device. Alternatively, at a step 610 in response to scanning and processing the QR code, the software in the user device can download all the site information from the system. The user device can then use that information to provide an augment reality for the user. For example, the user device can displaying additional information over top of images captured through the device's camera. The additional information can be, for example, RFR exposure levels. In addition, the various operations just described can be presented on the display of the user device as choices which can be selected by the user.

Alternatively, the user device can be a mobile communication device, such as a smart phone, having a standard QR reader. At a step 614, the user scans the QR code using the mobile device in a standard QR reader. At a step 616 the QR reader then causes the phone application on the mobile device to open or launch. At a step 618 the user dials the telephone number that was obtained from the QR code and is displayed in the telephone application. At a step 620 the telephone number connects the user to a call center. The call center personnel can then confirm the caller's location and provide RF safety assistance. The telephone number of the call center is represented in the QR code.

Alternatively, the QR code can indicate the address of a web site. For example, at a step 624, the user scans the QR code using their mobile device including the standard QR reader. At a step 626 the QR reader causes the web browser of the device to launch. At a step 628 the web browser displays site information specific that site and includes a link for placing a telephone call for assistance. When the worker clicks on that link, at a step 630 the phone application in the mobile device opens with the telephone number from the website. The worker can then call that number in a step 632. At a step 634, as was explained in connection with step 620, the user is connected to a call center supported by individuals trained for RFR safety support.

Alternatively, at a step 638, the user scans the QR code using their mobile device including the standard QR reader. At a step 640 the QR reader causes the web browser of the device to launch the web browser displays site information specific that site and includes a link for receiving a telephone call for assistance. At a step 642 the user selects that link. At a step 644 an operator in the call center previously described receives an alert including the telephone number of the mobile device. The operator calls that number and is connected to the user.

Alternatively, at a step 650, the user scans the QR code using their mobile device including the standard QR reader. At a step 652 the QR reader causes a messaging application (e.g., text messaging) of the device to launch. Using data from the QR code, a message is displayed that is prepopulated with the basic identifying information for the site, the telephone number of the mobile device and a preselected message address. At a step 654 the worker sends the message in order to receive a call back from the call center. At a step 656 an operator in the call center previously described receives an alert including the telephone number of the mobile device. The operator calls that number and is connected to the user.

In each of the above described methods, the time of the contact from the worker, the telephone number of the worker and the location of the site (and the worker) can be saved, for example as part of the site compliance report 242.

Referring back to FIG. 6, at the site information step 536, or FIG. 5 module 428 the user can access the functions in the contacts module 437 shown in FIG. 5. The System provides the user with a contacts module. At step 536 of FIG. 6 the System provides the user the option to go to the power down request module 434 of FIG. 5.

FIG. 8A is a flow diagram of the power down request functions which can be implemented by modules 434 and 440 of FIG. 5. At step 710 a power down request interface provides the user with the ability to send a power down request for one or multiple antenna structures from a selected site. At step 720 the process provides the user with the ability to enter details relating to the power down request. At Step 722 a power down request email is generated and sent to the broadcaster associated with the antenna, and a confirmation email about sending the power down request is sent to the user, and then a database record about power down request is created. At step 724 if the power down is successful a screen is displayed at 710 stating the emails have been successfully sent.

FIG. 8B is a flow diagram of the functions performed once a power down request email is sent to the transmitter owner or operator. This request is sent automatically by database administration module 444 FIG. 4. At Step 726 at predetermined time intervals a check is carried out to determine if a response from the transmitter owner or operator has been received. If a response is received from the transmitter owner or operator the process proceeds to step 722. At step 722 the response is saved in the database. At step 722 a power down email confirmation is also sent to the user to confirm that the transmitter owner or operator received the power down request. This email may also contain further power down request information. If step 726 determines that no response has been received from the transmitter owner or operator the process proceeds to step 728. Step 728 determines what type of power down request has been sent. In one embodiment the types of power down requests include scheduled and emergency. If the power down request is determined to be an emergency the process proceeds to step 732. At Step 732 the system administrator contacts the transmitter owner or operator directly and notifies them that the antenna structure must be shut down. If the power down request is a scheduled power down the process proceeds to step 730. Step 730 determines the number of repeated power down requests which have been sent to the transmitter owner or operator. If step 730 determines that less than a defined value of repeated power down requests have been sent, step 730 sends another power down request email to the transmitter owner or operator. If step 730 determines that more than a defined value of repeated power down requests has been sent, the system proceeds to step 732. If the system administrator contacted the transmitter owner or operatory successfully the system proceeds to step 722, as if the response was received from the transmitter owner or operator.

FIG. 9 is a flow diagram of one embodiment of the process implemented by the data update administration module 447 of FIG. 5. At step 810 data update reminders are sent to all defined users. Defined users and their entered information is obtained from the user database and email reminders are transmitted to each such user. At step 812 the email displays a data update reminder to the user. At step 813 the user can select from action choices including data update or decline data update. If the user chooses the data update function the module routes them to step 820 where the user action, in this embodiment, database update, is “recorded”, in the database. At step 821 the user is provided with an interface for making the update. In one embodiment this interface is made through module 432 of FIG. 5. The quality of the data is checked and the process continues to step 822 where the System verifies any significant change of the data that could affect site's specific safety program. If there is any significant change, a new site safety program is created by module 824. At step 826 the module stores the information, in the database. After receiving a response from the server side script, a screen displays information about success of update.

At step 813 if the user declines to update the data, the process proceeds to step 818. At step 818 the user's action, in this case decline the database update is “recorded” in the database. At step 813 if the user takes no action the process proceeds to step 814. At step 814 the process either sends a second reminder or generates a prompt for an administrator to contact the transmitter operator or owner by telephone or other means. This choice based on the number of times the process has received no action from the user.

FIG. 10 is a graphical representation of a physical site 900 and a generalized site data structure. FIG. 10 is intended to clarify the relationship between the data structure depicted more completely in FIG. 2 and a physical site that can be represented by the data structure. Each site 900 (represented as element 210 in the data structure) may include one or more (generally indicated by the notation “(n)”) antenna structures 910 (represented as element 212 in the data structure). Each antenna structure may include one or more antenna systems 920 (represented as element 214 in the data structure) and each antenna structure may further include one or more groups of antennas 930 (represented as element 216 in the data structure). Each antenna group can include one or more antennas 940 (represented as element 218 in the data structure)

FIGS. 11, 12 and 13 will now be described in connection with one embodiment of a System used to define the spatial relationships between elements of a site. Those figures are examples of displays provided by the System to users' access devices where they can be displayed and/or printed.

FIG. 11 is a graphical representation of a system which can be employed to define the spatial relationships in a horizontal plane between multiple antenna structures at a site which are stored in the database. In the example depicted in FIG. 10 three different antenna structures 1010, 1020, and 1030 are located at one site. Alternatively, one or more of the antennas can be located inside or on a building. Antenna structure 1010 has one associated tower 1012 and three sectors 1014(a), 1014(b) and 1014(c). Antenna structure 1020 has three associated towers 1022(a), 1022(b), and 1022(c), and three sectors 1024(a), 1024(b) and 1024(c). Antenna structure 1030 has one associated tower 1032 and two associated sectors 1034(a) and 1034(b). These antenna structures are mapped on an X, Y coordinate system. The first antenna structure 1010 is defined as the base location and has the coordinates of X:0 and Y:0. The coordinates of the remaining antenna structures at the site are defined relative to the first antenna structure. The amount of precision in the coordinates may be selected based upon the measurement technique employed and the precision desired in any calculations which use the coordinates.

The location of antenna structure 1020 is defined in relation to antenna structure 1010. Each tower associated with the antenna structure receives a location value measured relative to its antenna structure location. In the example portrayed in FIG. 10, (Top view) antenna structure 1020 has coordinates X:100 and Y:75 measured from the center of the antenna structure 1020 in relation to the center of antenna structure 1010. This value corresponds to the database antenna structure table 220 of FIG. 2. In one embodiment the locations of towers of an antenna structure are defined as an offset from the location of associated antenna structure. For example, the towers associated with antenna structure 1020 have the following values in relation to the center of the antenna structure. Tower 1022 (a) has an x offset of 5 and a y offset of 20, tower 1022(b) has a x offset of 25 and a y offset of −28 (the offset is measured from the center of the antenna 1021 as such when the tower is left or down from the antenna structure center, the values are negative) and tower 1022(c) has a x offset of −25 and a y offset of −15. These values correspond to elements in the database tower table 224 of FIG. 2. The coordinates and offsets for the other antenna structures and towers are shown in the figure.

FIG. 12 is a graphical representation of a site plot map based upon data stored in the system which defines the spatial relationships in a horizontal plane between multiple antenna structures at a site and can be provided to users in the site plot map preview. In the example depicted in FIG. 11 three different antenna structures 1030 are located at one site. The Site plot map shows these antenna structures on the area that represents building rooftop 1020. Additionally non-RF elements 1040 are presented such as Air Condition (AC), equipment box, or access point. The system can send this representation to the user's access device where it is displayed.

FIG. 13 is a top view of antenna system's MPE map as presented by module 430 of FIG. 4. Antenna system MPE map 1110 includes antenna system identification 1120 and legend 1130 which includes a description of the graphic elements used for the MPE map. The MPE map includes a graphic representation of the antenna system 1170, non-RF elements 1140 and the controlled 1150 and restricted 1155 areas of the MPE maps including dimensions 1160 as required by the Site-specific Antenna Safety Program.

FIG. 14 is a side view of the antenna system's MPE map as presented by module 430 of FIG. 4. Antenna system MPE map 1210 includes an antenna system identification 1220 and legend 1230 which includes the description of the graphic elements used for MPE map. The MPE map includes a graphic representation of the antenna system 1270, non-RF elements 1240 and the controlled 1250 and restricted 1255 areas of the MPE maps including dimensions 1260 as required by the Site-specific Antenna Safety Program.

The MPE maps module 430 calculates power densities for antennas in the database and creates graphic representations of the power densities. Example representations are depicted in FIGS. 13 and 14 described below. In one embodiment, the graphic representations are in the form of radiation pattern maps. In one embodiment the radiation pattern maps graphically depict the power densities and physical landmarks, for example, interior features of a building (when the power densities are inside a building), towers and emitters. The calculations of power density and the creation of graphic representations of the densities can be used to determine and maintain site safety and to comply with government regulations (e.g., OSHA and FCC regulations) and to comply with other safety standards.

The graphic representations of the MPE maps provide the user with projected gradation patterns of power density. In one embodiment, the maps show two distinct areas, restricted and controlled MPE areas, which are defined in one example by FCC/OSHA standards. MPE maps for the controlled areas represent the areas where the power density of the RF fields exceeds the limits for the general population. MPE maps for the restricted areas represent the areas where the power density of the RF fields exceeds the occupational MPE limits. The power density in the controlled areas is above the general public limits but not above the occupational limits for RF trained workers. However, more than two areas or regions can be defined and displayed. In general, the MPE maps module can display various gradation distinctions based on selected density values. The power densities created by multiple antenna structures in some instances owned by different wireless telecommunication companies can be generated to show cumulative density. Alternatively, these modules can be used to calculate all power densities for a site. This is extremely beneficial if a person needs to do maintenance at a site so that they can determine how far from each antenna structure they must remain in order to be at a safe distance.

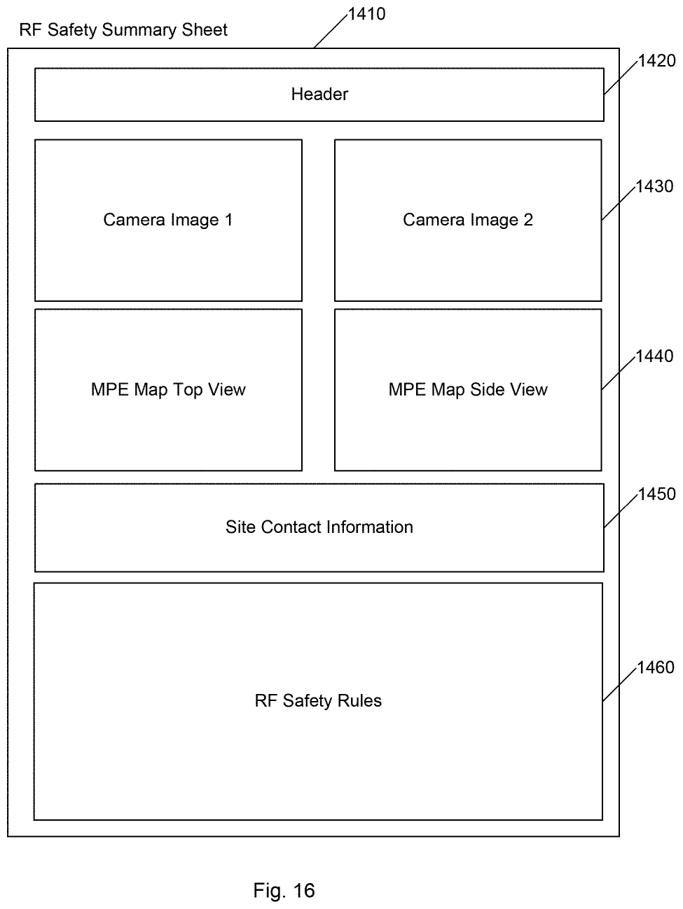

In one embodiment the MPE maps graphic representations and the power density calculations for antenna structures with multiple antennas can be determined using a single antenna model (FIG. 14B), conservative model (13 A) or the contribution model (FIGS. 16, 18 and 19). The conservative model considers one antenna sector as one antenna with power equal to the sum of the power of all antennas in the sector. The conservative model can be used in situations where it is not possible to calculate the individual contribution of the antennas and where it is not certain if the antennas are used as a transmitter or receiver. The contribution model creates a more accurate graphic representation of the MPE maps by calculating the contribution of each of the antennas in the sector.

Some example equations used to calculate power density which can be used for MPE maps are set forth below. In one embodiment the MPE map module 430 FIG. 5 can calculate power density for a variety of different antennas through the use of applicable mathematical models which have been enhanced by field measurement results stored in the data base.

The following calculations can be used to predict power density levels around typical RF sources.

$$\begin{matrix}S = \frac{P \cdot G}{4 π {R}^{2}} & 1 \\ S = \frac{EIRP}{4 π {R}^{2}} & 2\end{matrix}$$

where: S=power density
P=power input to the antenna
G=numeric power gain of the antenna in the direction of interest relative to an isotropic radiator
R=distance to the center of radiation of the antenna
EIRP=equivalent (or effective) isotropically radiated power

For prediction of power density near a reflective surface, a 100% reflection of incoming radiation can be assumed, resulting in a potential doubling of predicted field strength and a four-fold increase in power density. In that case Equations (1) and (2) can be modified to:

$$S = \frac{{( 2 )}^{2} P \cdot G}{4 π {R}^{2}} = \frac{P \cdot G}{π {R}^{2}} = \frac{EIRP}{π {R}^{2}} \qquad 3$$

The equations (1), (2), and (3) are generally accurate in the far-field of an antenna but will over-predict power density in the near field, where they could be used for making a “worst case” or conservative prediction. Following equation can be used to predict power density close to antenna surface

$$S = ( \frac{180}{{θ}_{BW}} ) \frac{{P}_{net}}{π Rh} \qquad 4$$

where: S=power density
   Pₙₑₜ=net power input to the antenna
   θ_{BW}=beam width of the antenna in degrees
   R=distance from the antenna
   h=aperture height of the antenna
      Equation (4) can be used for any vertical collinear antenna including omni-directional antennas where θBW would be 360 degrees.

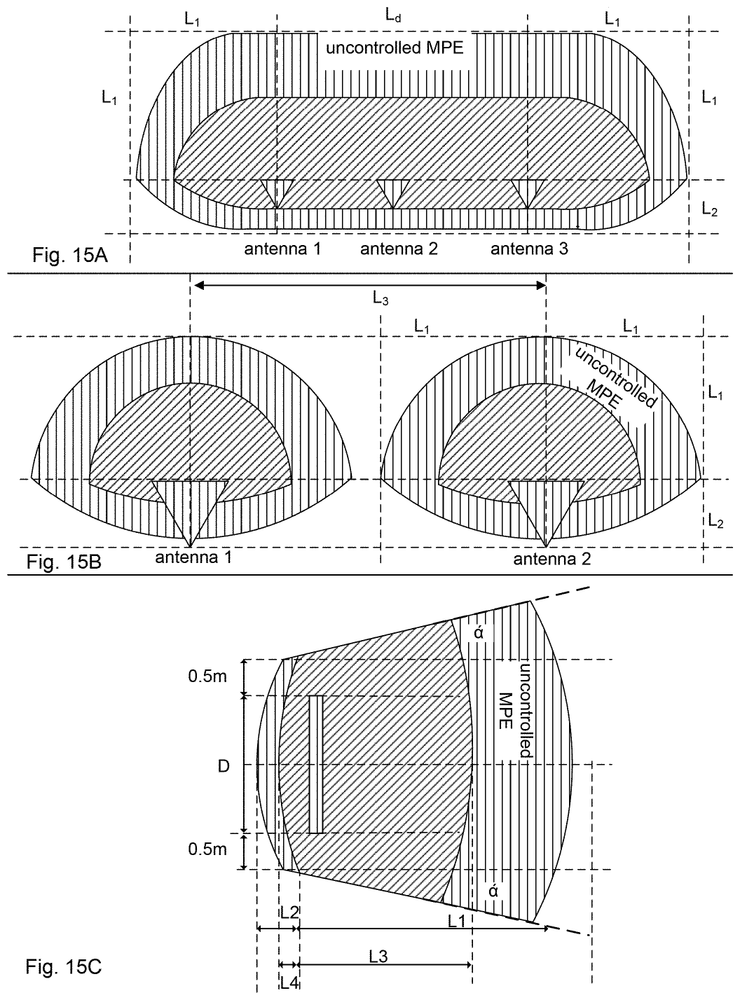

The MPE maps module 436 as represented in FIG. 5 provides radiation pattern maps which show the power density limits for restricted, controlled and general public MPE boundaries. The radiation pattern maps depicted in FIGS. 14 and 15 show two different levels of density based on the exposure limit ranges set forth in the following tables:

Controlled Exposure (Limits for Occupational)

| Frequency Range (MH_{z}) | Power Density (S) mW/cm² |
|---|---|
| 30-300 | 1.0 |
| 300-1,500 | f/300 |
| 1,500-100,000 | 5.0 |

General Public Exposure (Limits for General Population)

| Frequency Range (MH_{z}) | Power Density (S) mW/cm² |
|---|---|
| 30-300 | 0.2 |
| 300-1,500 | f/1500 |
| 1,500-100,000 | 1.0 |

FIG. 15A is a graphical representation of a MPE map from the top view perspective for three antennas with overlapping controlled and restricted areas represented. In one embodiment, these gradations include the occupational RF “restricted” and “controlled” areas based on the MPE limits. FIG. 15A is a top view for three antennas or transmitters with overlapping controlled and restricted MPE regions. FIG. 15B is a graphical representation of a MPE map from the top view perspective for two antennas with non-overlapping controlled and restricted areas represented, and where a single antenna mathematical model was applied. FIG. 15C is an example of a side view of an antenna as represented in FIG. 15A or 15B. In these figures, L1 is the extent of the controlled areas which is the distance in which power density reaches its limits for general public MPE. L2 is the extent of the controlled area on the back of the beam and equals L1 multiplied by the front-to-back FB ratio from database table antenna model 260. The front-to-back ratio stored in the database table 260 is obtained from the manufacturer's technical specification. L3 is the distance in which the power density reaches its limits for controlled MPE. L4=L3 multiplied by the front-to-back ratio. Ld is the distance between the center of the antennas furthest apart. D is the height of the antenna.

FIG. 16 is a block diagram representation of the data included in the RF Safety Summary Sheet (RF SSS) presented in the system by module 431 of FIG. 4. RF Safety Summary Sheet 1410 includes Header 1420 that identifies the site and the version of RF SSS; Camera images 1430; MPE maps 1440; site contact information 1450 such as property owner representative or licensee; and RF Safety Rules 1460 that describes in details rules that worker has to follow. The information allows the system to provide safety information that is specific to each site.

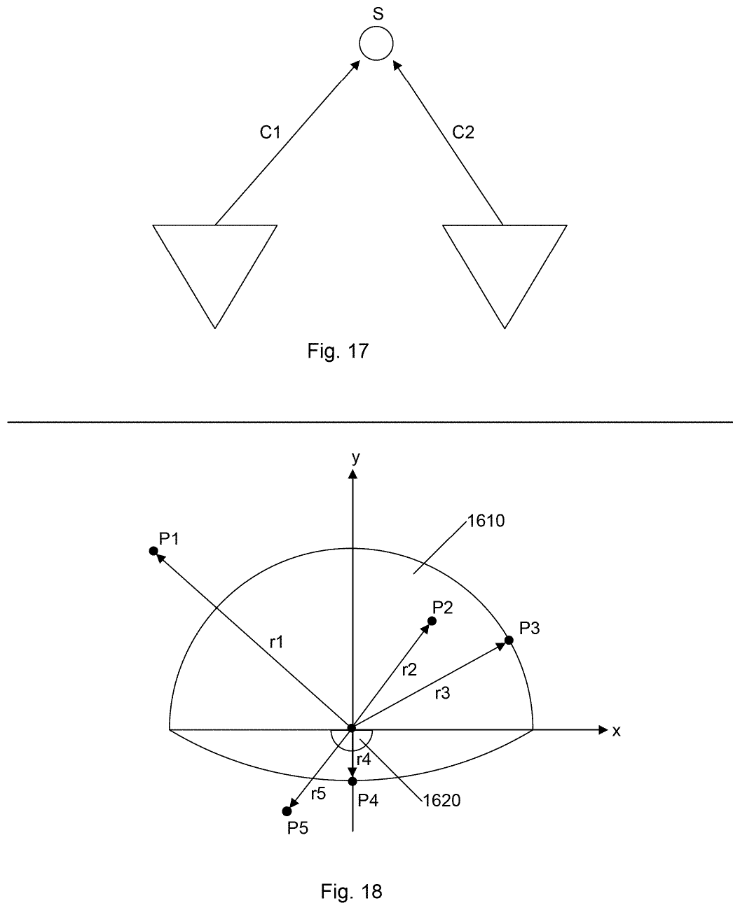

FIG. 17 represents the power density which is created as a contribution of two antennas. C1 represents the contribution from antenna 1, C2 represents the contribution from antenna 2 and S is the power density at a particular point. Power density S is calculated as the contribution of the power densities of antennas 1 and 2, expressed as a percentage of the exposure limit. The graphic representation is based on calculations of the contributions of all the involved antennas in the site. The calculations for the percent contributions of antenna 1 and antenna 2 are set forth in Equations 6 and 7 below.

$$\begin{matrix}C 1 = \frac{{S}_{1}}{{S}_{1} stnd} & 6 \\ C 2 = \frac{{S}_{2}}{{S}_{2} stnd} & 7\end{matrix}$$

Where:
S₁=power density of antenna 1
S_{1stnd}=exposure limit of antenna 1
S₂=power density of antenna 2
S_{2stnd}=exposure limit of antenna 2

The known variables in these equations are the position of the antennas in two dimensional space based on an X and Y coordinate system set forth in FIG. 11 and FIG. 13, and the limit of the power density, for example, as defined by a governmental regulation.

FIG. 18 represents the power density of a single antenna in different points in space. The point at P1 has a power density under the limit beyond the MPE boundaries. The point P2 has a power density above the limits which falls within the MPE boundaries. The point P3 falls on the outer edge of the MPE boundaries and has a power density equal to the limit, referred to as the limit point. Point P4 is at a distance r4 from the antenna and r4=front-to-back ratio multiplied by r3. The antenna 1620 has a front-to-back ration of 10% and therefore P4 has a power density equal to the limit as does P3. Point P5 is located outside of the antenna's rear radiation MPE boundary.

In order to calculate the power densities for such a site with more than one more antenna structure, the standard MPE limits calculations need to be modified in order to generate cumulative radiation patterns which include the contribution of all the individual antennas. To calculate the power density at certain point in the P1 and determine whether it exceeds acceptable limits, the total sum of individual contributions of the various antenna at the site need to be calculated. P_{c} is the calculation used to determine whether the power density at a particular site is below or in excess of acceptable limits. If p_{c} is greater than 1, the power density is above acceptable limits. If p_{c} is less than 1, then the power density is within acceptable limits. In order to calculate p_{c}, equation 8 set forth below is used.

$${p}_{c} = \frac{pa 1}{ps 1} + \frac{pa 2}{ps 2} + ⋯ + \frac{{pa}_{n}}{{ps}_{n}} \qquad 8$$

Where:
pa1=is actual power density based on r1 (distance from center of the
antenna) and antenna power
ps1=is known limit for antenna a1
pc=number that expresses if the power density reaches its limit
   With this calculation the values obtained from each antenna at a site are added together to determine if the power at the particular point in space exceeds the MPE limits. Even if individual radiations at a particular antenna do not reach the MPE limits, the final radiation as a contribution of all antennas may reach the MPE limits. It is important to note that power density limits for individual antennas could be different for each antenna.

FIG. 19 represents the power density contribution of two antennas to a point in space. It is a diagram which represents the power density contribution of two antennas 1710 and 1720 to a point in space labeled P1. The individual radiation pattern map of antenna 1710 is shown at 1712 and the individual radiation pattern map of antenna 1720 is shown at 1722. The combined radiation pattern map for both antennas is represented by 1730.

FIG. 20 is a diagram which represents the participation of multiple antennas in the contribution model applied to an antenna array. There are three sectors represented in FIG. 20 being 1810, 1820 and 1830. The points labeled P1 and P2 are used to discuss power density at those points in two dimensional space in a contribution model. The power density at P1 is affected by antenna 1 (1819), antenna 2 (1818), antenna 3 (1816) and antenna 4 (1814) at sector 1810. All of the antennas on sector 1810 contribute to the power density at P1. The power density at P2 is affected by antennas 1819, 1818, 1816, 1814 of sector 1810 and antennas 1834 and 1836 of sector 1830. P2 is within the area where possible contributions of sector 1830 and sector 1810 overlap and therefore the power contributed by antennas on both sectors are taken into account.

FIG. 21 is a flow diagram of one embodiment of an Automated Safety Audit Program of FIG. 5. Site specific safety program module 433 of FIG. 5 provides user access to a site specific safety program (SSSP) 1940 which includes the site specific RF Safety Summary Sheet. One embodiment of a SSSP 1940 as depicted in FIG. 20 contains the following categories of information:

“program administration” which includes policies, RF safety officer information, contacts and documentation;
“identification of RF hazards” which identifies RF sources and MPE maps for the site
“controls” which includes energy controls, signs to look for, safe work practices, RF monitoring, and personnel protective practices;
“training” which includes training programs for general public workers in areas where RF energy is too low to cause exposure above public limits, for workers in areas where energy may cause exposure above public limits, and for workers in areas where RF may cause exposure in excess of occupational limits unless workers utilize special controls and records of who has received the training;
“program audit” which contains information regarding responsibilities and audit reports; and
“ancillary hazards” can include, for example, fall protection, the identity and locations of hazardous materials at the site, lockout agent, and extreme weather precautions. The data for the SSSP is contained in the database (see FIG. 2 table 214). The automated safety audit program updates a site's safety program when relevant changes are made at the site.

Referring to FIG. 21 automated safety audit program processes the database update file from the user at step 1900. In one embodiment, the update data file includes an array of keys and values, where ‘key’ is the identification of the columns in the database and ‘value’ is an updated value. If the file does not include a key for the particular database column, the process considers that the value was not changed and the current value is used if the site specific safety program (SSSP) (or the RF Safety Summary Sheet) needs to be changed. If new data is entered, the process proceeds to step 1905. At step 1905 the data entered by the user is processed by the System. The process determines if the updated values effect the existing SSSP, or if data directly include values that need to be changed in the SSSP. The following are examples of this process.
Example 1: If the input power of the transmitter is changed, this will change the location of the MPE boundaries. The MPE limits would then need to be recalculated and the existing SSSP would need to be changed. A new or modified SSSP would then be generated to replace the existing one.
Example 2: if the data update file includes a new site's RF safety officer, the information for the RF safety officer would need to be changed and a new SSSP would then be generated to replace the existing one.
Example 3: If the broadcasting frequency was changed, but it doesn't affect any part of the existing SSSP, then a new SSSP will not be generated.
Example 4: If the floor plan of a site is changed, the location of transmitters associated with the site would change relative to the boundaries of the floor. This can affect determining the exact location of a transmitter within a building. A new or modified SSSP would then be generated to replace the existing one.

At step 1910 if no change to the SSSP is required the process ends. However, if a change to the SSSP is required the process proceeds to step 1915 where a new or modified SSSP is generated. Once a new SSSP is generated, the system proceeds to step 1920 where the new SSSP is entered into the database. At step 1925 the new SSSP is given a unique id and assigned to the site. At step 1930 the process records the SSSP id change in the database. This record includes data on the old SSSP id, the new SSSP id, and the site identification code as seen in table 210 and 214 of FIG. 2.

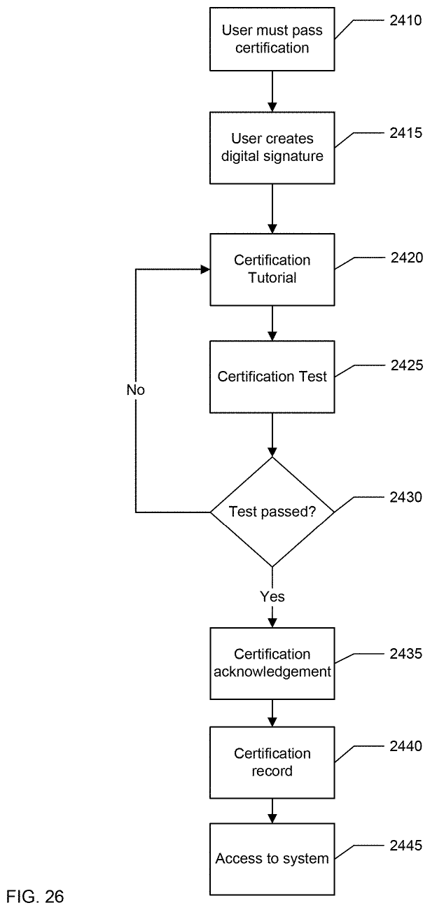

Though the foregoing description focused on the SSSP, it should be noted that the process also applies to the site specific RF Safety Summary Sheet. Additionally, if the RF Safety Summary Sheet is updated during the process, previously issued site specific certifications are indicated as invalid in the database. Additionally, such an update to the RF Safety Summary Sheet can trigger the process described below in connection with FIG. 26 where the system prompts a user to obtain a certification (in this case a re-certification). Notices can also be sent by the system to registered users that have received the site specific RF Safety Summary Sheet informing them that the old sheet is no longer valid.

FIGS. 22 and 23 are flow diagrams of one embodiment of an automated compliance audit program (ACAP) implemented by the automated compliance audit module 446 of FIG. 5. The System executes a periodic, for example, monthly, ACAP for every site and creates and stores a monthly compliance certificate report (MCCR) as shown in FIG. 22. In one embodiment the MCCR includes the site code and the date (header), indicates whether the data has been updated since the last audit (MCCR-1), indicates what changes were made to the site since the last audit (MCCR-2), lists both the old and new safety programs if a new program was created (MCCR-3) and states whether the site is in compliance (MCCR-4). If the site is not in compliance the System sends a notification to the appropriate party. The System can also execute an annual compliance certificate report (“ACCR”) for all users and the sites they manage. The ACCR reports can be automatically generated and sent to the users as seen in FIG. 23. The MCCRs and the ACCRs are generated as computer records and/or printed. The computer records are time stamped and encrypted so that they cannot be altered. These reports are designed to meet the requirements of all applicable regulations, such as international, Federal and State regulations.

Referring to FIG. 22 at step 2005 the process checks the database for any new data updates since the last audit. At step 2010 if no data updates are found, the System generates an MCCR-1 record indicating that no changes have occurred. The process proceeds to step 2020 where the previous MCCR is retrieved. The MCCR is updated monthly and used in the final site compliance statement MCCR-4. The process determines whether the site is in compliance with the current regulations applicable to that site. The System includes all applicable regulations. The System can also determine which regulations apply to the site. Whether the site is in compliance is then added to the MCCR. If the site is not in compliance, the reason for the non-compliance is added to the MCCR and notification is sent to the appropriate party. For example the reason could be “failure to list RF safety officer” or “exceeds the MPE limits”. Finally, the MCCR record is time stamped and encrypted so that it cannot be altered.

At step 2010 if updated data is found, the process proceeds to step 2030. At step 2030 the process retrieves data changes from the database. At step 2035 the process determines if the data changes relate to the site's physical attributes, for example effective radiated power, antenna height, antenna type, new transmitters, transmitter location, floor plan. If the changes relate to the sites physical attributes, the process generates a list of old and new values which are stored in the MCCR and the process proceeds to step 2040. If the changes don't relate to the sites physical attributes the process proceeds to step 2040. At step 2040 the process verifies any change in the site specific safety program (or the RF Safety Summary Sheet) since the last MCCR. If a change occurred the System creates an MCCR record that lists the old and new site safety program and the process proceeds to step 2045. At step 2045 the System analyzes updated data and determines if the site is in compliance with the applicable regulations. At step 2050, if the site is in compliance, the System creates site compliance statement MCCR-4 which states “IN COMPLIANCE” and ends the process. If the site is not in compliance, the System sends notification to appropriate party, creates a site compliance statement MCCR-4 which states “NOT IN COMPLIANCE”, describes the reasons for the non-compliance and ends the process.

Referring to FIG. 23 at step 2105 the process retrieves the MCCR's from the database for the site being audited. At step 2110 an ACCR is generated by compiling all of the data from the MCCR's. The ACCR contains a site code year and an annual compliance certificate report. At step 2120 the ACCR is time stamped, encrypted and stored in the database. Additionally, a copy of the ACCR can be sent to the user associated with the site.

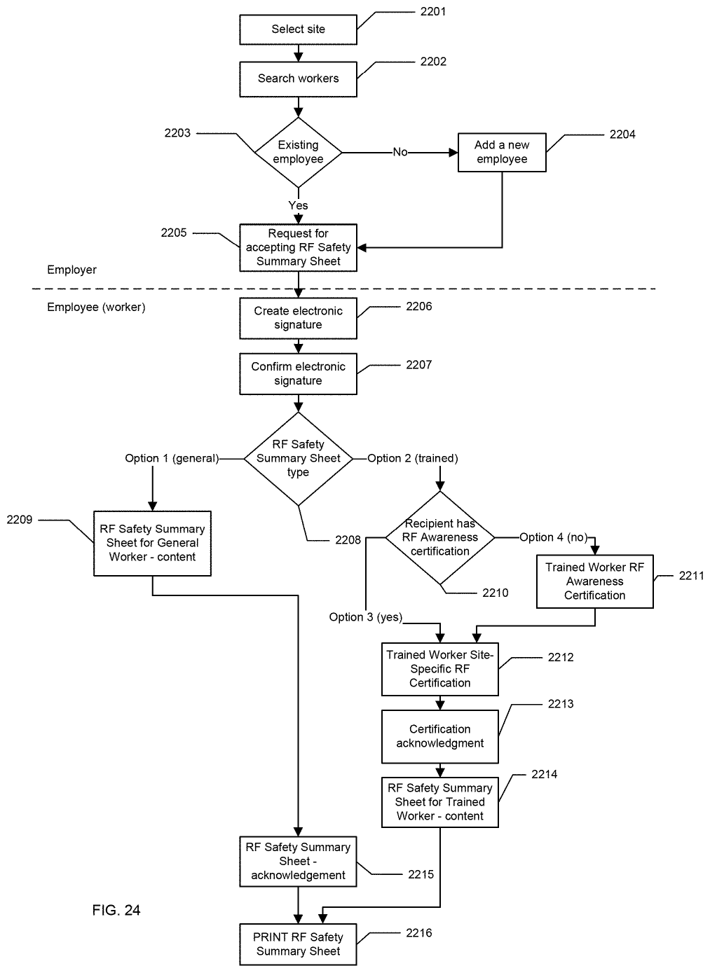

FIG. 24 is a flow diagram of functionality provided by the RF certification module 429 of FIG. 5. A user can access the module via the site information display as was mentioned above. The module allows a user to search for any worker listed in the database or only those workers that have received RF Certification step 2202. In one embodiment, the user's search is limited to employees of the user's company or organization. If the search does not present the desired employee (step 2203), the system allows the user to add a new employee to the database at step 2204. The system also provides the ability to issue the appropriate Site Specific RF safety summary sheet to either type of worker (new or existing) beginning with the request sent by employer to his employee at step 2205.

In one embodiment, the module presents all RF trained workers (employees) for the selected site at step 2202. To be qualified, the employee must have a current Worker RF Awareness Certification (e.g., certification date is equal to or less than one year old). Additionally, if the User requests general workers, the system will present all employees that do not have a current Worker RF Awareness Certification but have acknowledged the Site Specific RF safety summary sheet (acknowledgement date is equal to or less than one year old). If the database indicates that the candidate (worker) has acknowledged the receipt of the current Site Specific RF safety summary sheet for Certified Worker, the acknowledgement date will be presented. The system determines whether the acknowledged Site Specific RF safety summary sheet is identical to the current version. If the user wishes to view additional details of any selected worker, they can select the view details option. The system allows the User to request that his worker become part of the system database. This request is based upon the need to provide a RF Certified or General Worker with the appropriate Site Specific RF safety summary sheet or to provide a user's worker with a Worker RF Awareness Certification. If the User is adding a new worker (step 2204), the user must select the, month and day of the birth date of the desired worker, the last 4 digits of the desired worker's Social Security Number (SSN) (or other identifier), and worker's first and last name. When the User has entered the above fields, they can select the Lookup function and the system will determine whether the worker was previously entered into the system. The system will perform an exact match on date of birth and the last 4 digits of the worker's SSN. If the worker is found in the database, an informational message will be presented and the contact information fields will be filled with the information contained in the database. If the worker is not duplicated, the user must provide the additional information about the worker such as title, address, email address, phone number.

At step 2205, the user can select a “Provide Site Specific RF safety summary sheet by Email” option. Then, the system will validate that the selected worker has an associated email. If the email exists, the system annotates the date and time that the request was sent. The system also creates a secure link and sends an email to the selected worker. If the user selects the Provide on-site option, the system will annotate the date and time that the worker was presented the electronic signature screen. If the user stops the process before selecting the Provide Site Specific RF safety summary sheet option, the system will logoff the user to restrict the worker's system access privileges.

A worker electronic signature page is implemented by the module as represented by steps 2206 and 2207 and provides reasonable evidence that the intended worker is the individual that will participate in the Trained Worker RF Certification and/or Trained Worker Site Specific RF Certification. At step 2206 the worker enters their date of birth month and day, last 4 digits of their Social Security Number, and their first and last name. The system performs an exact match on date of birth, the last 4 digits of the worker's SSN and the worker's last name. Upon all fields successfully matching, the worker will be presented with the Electronic Signature Confirmation page at a computer station being used by the worker at step 2207. The purpose of the Worker Electronic Signature Confirmation page is to affirm and record that the worker accepts the presented signature as an authorized and binding signature. The Worker Electronic Signature Confirmation screen presents the worker's personal and contact information as read-only information. It will also “stylize” the first and last name of the individual. Lastly, it will stylize the first and last name initial as the individual's electronic Initials. The individual may select the “I accept my electronic signature” or Cancel option. If the individual selects the “I accept my electronic signature” option, the system will determine the appropriate Site Specific RF safety summary sheet to present to the individual (Step 2208).

If the individual was requested for Trained Worker RF Certification only, the system will present the current version of the certification. The system will create a secure (unique) document id that is comprised of the following: First Name, Last Name, Birth Date, Last 4 digits of the worker's SSN (or other identifier), System date and time, and Document ID. The Document ID is the Document Name and Version number. For example WGRFAC-V1.7 would indicate Trained Worker RF Certification, version 1.7.

Based on the request type from the worker's employer, the system will choose next steps in the process as represented by step 2208. Option 1 is for a General Worker—Site Specific RF Safety Summary Sheet for General Worker. If the individual was requested for a Site Specific RF Safety Summary Sheet for General Worker, the system will present the Site Specific RF Safety Summary Sheet for General Worker as indicated at step 2209. The General Worker then must acknowledge to the system the RF Safety Summary Sheet for General Worker at step 2215. In step 2216, the General Worker can print the Site Specific RF Safety Summary Sheet for General Worker.

Option 2 is for a Trained Worker—Site Specific RF Safety Summary Sheet for trained Worker. In order to receive the Site Specific RF Safety Summary Sheet for a trained Worker, the worker must complete the Trained Worker RF Certification and Trained Worker Site-Specific RF Certification provided by the system. The system will determine first whether the individual has a valid Trained Worker RF Certification (Step 2210). If the worker has a valid Trained Worker RF Certification (Option 3 in Step 2210), the system proceeds to step 2212. If not (Option 4 in Step 2210), the system causes the worker to first complete the Trained Worker RF Certification (Step 2211) and the system then continues to step 2212.

After completion of the Trained Worker Site-Specific Certification (Step 2212), the worker must acknowledge his certifications (Step 2213) and this is indicated in the database. Once acknowledged, the worker can proceed to step 2214. At step 2214, the system presents the Site Specific RF Safety Summary Sheet for Trained Worker. The Trained Worker then must acknowledge the RF Safety Summary Sheet for Trained Worker (Step 2215) and the acknowledgement is indicated in the database. In step 2216, the Trained Worker can print the Site Specific RF Safety Summary Sheet for Trained Worker. The acknowledgement screens present the individual's name, current date & time, the specific site address and the system generated Secure Document ID created at the beginning of the process. The individual's previously accepted signature will be created and presented when the Sign option is selected.

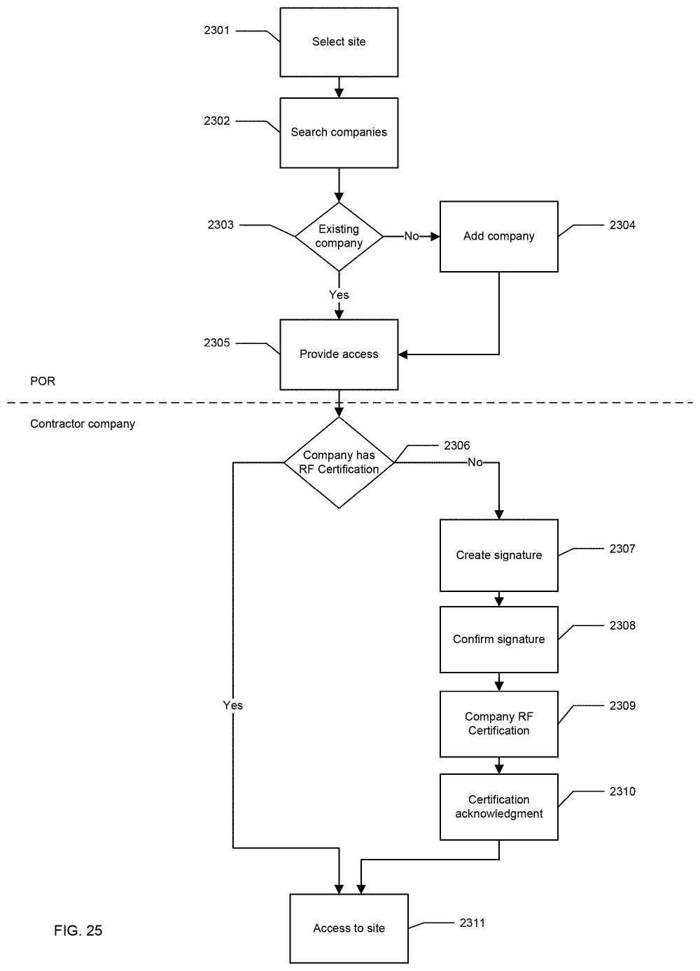

FIG. 25 is a flow diagram of further functionality provided by the RF certification module 429 of FIG. 5 which allows a user to provide contractor companies the system functionalities of site access, training and certification similar to that provided for employees. This functionality addresses the need to provide a RF Trained or General Worker of a subcontractor with the appropriate RF Safety Summary Sheet and to provide a subcontractor's workers with Trained Worker RF Certification.

After a site is selected at step 2301, the module allows the user to find, in the database, companies (e.g., subcontractors) that are certified who also may have workers who possess: Trained Worker RF Certification, Site Specific RF Safety Summary Sheet for General Worker Acknowledgement, and Site Specific RF Safety Summary Sheet for RF Trained Worker Acknowledgement (including Site Specific RF Certification for Trained Worker). The system also allows the User to view details about a selected company or to begin the process of adding a new company to the database. At step 2302 the system provides the results of all companies with the closest company presented first and all others in ascending distance from the selected site. Information regarding the company can be presented, such as: Company name, Company Address, Number of workers with Trained Worker RF Awareness Certification, Number of the company workers that possess a valid Site Specific RF Safety Summary Sheet for RF Trained Worker, and Number of the company workers that possess a valid Site Specific RF Safety Summary Sheet for General Worker. The quantity represents the number of workers that possesses a valid Site Specific RF Safety Summary Sheet. To be considered valid, the Site Specific RF Safety Summary Sheet must be of the same version as the current version. The User may also search for a specific company name at step 2302. This system presents an ever-narrowing list of names by conducting a fuzzy match lookup as the User types. For example, as the user begins their typing, the system will return all names that best match the sequence of letters entered so far. The name can be presented along with the alphabetically ascending city and state in parenthesis. The user may also select a specific Company Type at this step. If the user wished to view additional details of any selected company, they can select the View Details option and the system will present additional information from the database related to that company. If the user wishes to add a company to the system, they can select the Add New option. If the user is adding a new company (Step 2304): The user must enter the desired Company's 9 digit Employer Identification Number (EIN) or combination of Sole proprietor's last name, date of birth and last 4 digits of SSN (Social Security Number) or other selected identifier. When the user enters a company identifier such as a Company EIN or Sole proprietor's last name, date of birth and last 4 digits of SSN, they can select the Lookup function to determine whether the company was previously entered into the system. The system can perform an exact match on, for example, Company EIN or Sole proprietor's last name, date of birth and last 4 digits of SSN. If the company is found in the database, an informational message is presented and the contact information fields will be filled with the information contained in the database. If the Company has not been previously entered, the user can create a new entry by entering the name, title, email address, phone numbers, company name and address. When the user is satisfied with their entries, they select Add to record the information in the database.

At step 2305, after the user has selected the desired company and wishes to provide that company access to their Site Specific RF Safety Summary Sheets, they select the Provide Company Access option. Selection of the Provide Company Access option causes the system to associate the selected site with the company (if not already associated) and send an email notification to the company (for example, to a selected authorized officer of the company) alerting them to the potential request for services. The system determines whether the company has not obtained their Company RF Certification, or no longer possesses a valid certification status (Step 2306), and if not, the system directs the company or its authorized officer the Company RF Certification procedure represented by steps 2307, 2308, 2309, and 2310. A purpose of the Company Electronic Signature page provides reasonable evidence that the intended company is the company that will participate in the RF Certification tutorials.

At step 2307, the Company Electronic Signature page is presented to a user, for example, by the user clicking on or following a secure link received by an email sent by the system. The sending of the email with the secure link can also be triggered by a system background task that determines when a company's certification becomes due. In that case, the system automatically sends out a re-certification email with a similar secure link as is sent for a new company. The information text in the email is prefaced with the company's responsible party's name & the Company's name. The Login ID will contain the email address of the recipient. The authorized individual must enter an identifier, for example, the company name and their 9 digit Federal Employer ID or Sole proprietor's last name, date of birth and last 4 digits of SSN. The authorized individual also enters a valid password and reconfirms the password. If the values entered by the authorized individual match those entered by the user, the Company record is created with the Login ID and Password recorded in the database. Upon all fields successfully matching, the system will present the authorized individual with the Electronic Signature Confirmation page represented by step 2308.

A purpose of the Company Electronic Signature Confirmation page is to affirm and record that the user accepts the presented signature as an authorized and binding signature. In the Company Electronic Signature Confirmation screen the system presents the company information as read-only information. It will also “stylize” the first and last name of the authorized individual to simulate an actual handwritten signature. Lastly, it will stylize the first and last name initial as the authorized individual's electronic Initials. The “I accept my electronic signature” option is enabled as is the Cancel option. If the user selects the “I accept my electronic signature” option, the system creates a secure (unique) document id. The document id can be comprised of the following: First Name, Last Name, EIN or Sole proprietor's date of birth and last 4 digits of SSN, and System date and time, Document ID. Document ID is the Document Name and Version number. For example GRFC-V1.7 would indicate RF Awareness Certification, version 1.7. This secure document id becomes part of the company's database history and can be used to provide evidence that the authorized company completed the specific training that is/was contained in the referenced document. After acceptance, the system will present the content of the applicable RF Certification tutorial and tests as represented by step 2309. The RF Certification tutorial and tests can be those discussed above in connection with Table tutorial 320 of FIG. 4. The operation of the tutorial and test is discussed further below.

At the completion of all of the tutorial sections and passing the certification tests, a final signature must be obtained as represented by step 2310. At this step the system presents the individual's name, current date & time and the system generated Secure Document ID created at the beginning of the tutorial process. The individual's previously accepted signature will be created and presented when the Sign button is selected. Selection of the Sign button will present the individual's signature created in the Company Electronic Signature page. After this the user is enabled to access the system as represented by step 2311. For example, the user can be presented with the Continue to Web Site button.

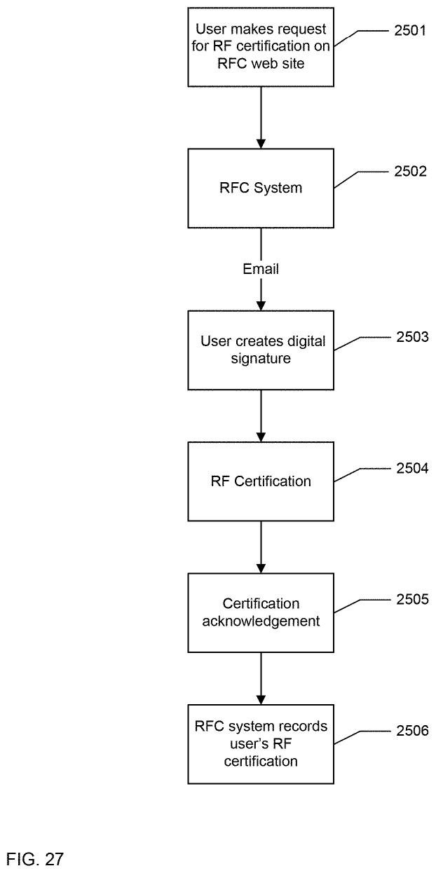

FIGS. 25 and 26 are flow diagrams of a processes for a user to obtain certification which can be implemented by the RF certification module 429 of FIG. 5. For example, this process can be used whenever the system requires a user to have a type of certification as represented by FIG. 26 or at the request of a user as represented by FIG. 27.

Referring to FIG. 26, the system determines that a user requires certification which is represented by step 2410. The system then directs the user to the beginning of the process for the appropriate certification. The user then creates a digital or electronic signature as represented by step 2415. That process has been described in connection with step 2206 of FIG. 24. Next, the user is taken through a certification process as represented by steps 2420, 2425 and 2430 In one embodiment, the certification process starts with the tutorial contained in the Table tutorial 320 of FIG. 4. The content of the certification process can be based upon government safety rules or laws or can be selected by the system operator. In one embodiment, the process is an interactive tutorial. Alternatively, written materials can be provided electronically. The certification process includes presenting a test to the user at the end of the tutorial as represented by step 2425. The test and the questions are stored in the tables 325 and 330 of FIG. 3. At step 2430 the system compares the user's test score with a minimum score on the test that is required in order to obtain the certification. If the user's score is less then the minimum required score, the user is redirect back to step 2420—certification tutorial. If the user passes the test, he must acknowledge his certification (2404) and this is indicated in the database. At step 2440 the system creates a record about the user certification using table 340 of FIG. 3. At step 2445 access to the system is granted to the user and—the user is directed to an initial page such as are implemented by modules 422 and 424 shown in FIG. 5.

Referring now to FIG. 27, a similar process for a user to obtain a certification at the request of the user is shown. The process can begin with a user making a request for a certification, for example at a public page provided by the system, such as a home page, which is represented by step 2501. The system then directs the user to the beginning of the process for the appropriate certification (2502). The user then creates a digital or electronic signature as represented by step 2503. That process has been described in connection with step 2206 of FIG. 24. Next, the user is taken through a certification process as represented by step 2504. The content of the certification process can be based upon government safety rules or laws or can be selected by the system operator. In one embodiment, the process is an interactive tutorial. Alternatively, written materials can be provided to the user electronically. The certification process includes presenting a test to the user at the end of the tutorial. A minimum score on the test can be required in order to obtain the certification. That process has been described in connection with steps 2420, 2425 and 2430 of FIG. 25. The user then must acknowledge his certification (2505) and this is indicated in the database (2506).

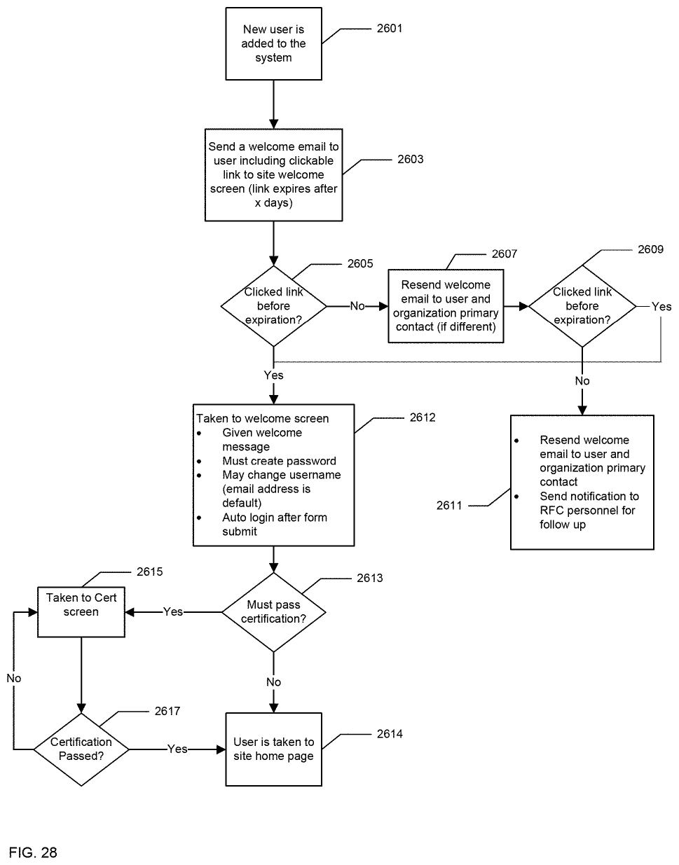

FIG. 28 is a flow diagram of further functionality which can be provided by the RF certification module 429 of FIG. 5. In general, the method shown in FIG. 28 is an example of how the module allows new users to be added, sends the new user an invitation (e.g., an email) and to begin the certification process if required.

Referring to FIG. 28, an administrator or existing using can add a new user by enter certain data about the new user, such as a name and email address as represented by step 2601. The system then contacts the new user, for example by sending an email with a link (step 2603). At step 2605, if the link is not activated before it expires, the email is re-sent (step 2607) and others can be notified. If the new user again fails to respond (step 2609) others can again be contacted and the email can be resent again (step 2611).

When the user responds to the invitation, they are taken through a welcome and registration process (step 2612). New users that need to pass certification (step 2613) are directed to a certification process represented by steps 2615 and 2617. This can be the process represented by FIG. 26. The content of the certification process can be based upon government safety rules or laws or can be selected by the system operator. A test can be presented to the user at the end of the tutorial (step 2617) and minimum score on the test can be required in order to obtain the certification. Then, the user is directed to an initial page such as are implemented by modules 422 and 424 shown in FIG. 5.

Besides the method described above, the system also allows a user (e.g., a worker or a sub-contractor) to initiate their certifications by clicking on a link or activating a button in other screens of the system such as the public web site (step 2501). The system then processes the user request and sends the user an email that contains a link to certification screens (step 2502). Completion of the Trained Worker RF Certification allows the worker to accelerate their future request for Site-Specific RF Certification by skipping step 2211 of FIG. 24. By completing the Trained Worker RF Certification, the worker also becomes part of the database system and is listed in the system as a RF trained worker. The worker becomes visible for other users of the system seeking a worker with an RF Trained Worker Certification. Completion of the Company RF Certification allows a company to accelerate a future request for accessing the system by skipping steps 2307-2310 from FIG. 25. By completing the Company RF Certification, the contractor company also becomes part of the system and is listed in the database as a company with RF Certification. The Company becomes visible (searchable) for other users of the system seeking a company with RF Certification.

Various embodiments may be implemented using a combination of both hardware and software.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention. References to a “page” refer to a visual display of information such as a web page or other representation of information presented to a user on a computer display device.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system for managing and viewing radio transmission information for a building comprising:
a database including data on a plurality of buildings and transmitters emitting radio frequency (RF) radiation to or inside one or more of the plurality of buildings; and
a maximum permissible exposure (MPE) mapping module configured to display a building's antennas and transmitters with associated elements, calculate a building's associated MPE limits, and create graphic representation of MPE maps.

2. The system of claim 1, wherein the database further includes data on at least one floor plan of one or more of the plurality of buildings.

3. The system of claim 2, further comprising an indoor positioning system having coordinates of each transmitter in relation to the at least one floor plan in the database.

4. The system of claim 1, further comprising a data update module configured to update the database when changes are made to one of the floor plans.

5. The system of claim 4, wherein changes made to one of the floor plans include repositioning of one of the plurality of transmitters.

6. The system of claim 1, further comprising:
a compliance audit module configured to maintain compliance for the plurality of buildings and to monitor for changes to compliance status when data associated with the plurality of buildings is changed.

7. The system of claim 1, wherein data on the plurality of transmitters includes data on an indoor distributed antenna system (“inDAS”).

8. The system of claim 7, wherein the data on the plurality of transmitters further includes data on a signal booster, a WLAN access point, or any other source of RF radiation.

9. The system of claim 1, further comprising a building information display module configured to provide the floor plan of one of the buildings.

10. The system of claim 9, wherein the building information display module is configured to be accessed by a first responder during an emergency.

11. The system of claim 1, further comprising a power down request module configured to allow a user to request that the power of a transmitter or multiple transmitters at a building can be reduced or turned off.

12. A system for managing radio transmission information for sites comprising:
means of storing data on a plurality of sites having transmitters emitting radio frequency (RF) radiation to the inside of each site; and
means of displaying a site's antenna structures and transmitters with associated elements, calculate a site's associated maximum permissible exposure (MPE) limits, and create graphic representation of MPE maps.

13. The system of claim 12, wherein the transmitters comprise an indoor distributed antenna system (“inDAS”), a signal booster, a WLAN access point, or any other source of RF radiation.

14. The system of claim 12, further comprising means of storing at least one floor plan of each site.

15. The system of claim 14, further comprising means to display the floor plan of one of the site.

16. The system of claim 12, further comprising means to allow a user to request that the power of a transmitter or multiple transmitters at a site can be reduced or turned off.

17. A method for managing safety training certification for radio transmission relating to buildings with high level RF radiation, comprising:
creating a database including data on a plurality of buildings having transmitters emitting radio frequency (RF) radiation to the inside of each building;
displaying a transmission site's antenna structures with associated elements;
calculating the transmission site's associated maximum permissible exposure (MPE) limits; and
creating a graphic representation of MPE maps;

18. The method of claim 17, wherein the transmitters comprise an indoor distributed antenna system (“inDAS”), a signal booster, a WLAN access point, or any other source of RF radiation.

19. The method of claim 17, wherein the database includes at least one floor plan of each building.

20. The method of claim 17, further comprising:
sending a request to an operator, a transmission site owner, a property management company and a city or municipality associated with the transmission site where the antenna structure is located;
creating a database entry about a power down request; and
sending a confirmation of the power shut down or power reduction to the user.
